(19) United States
(12) Patent Application Publication
(10) Pub. No.: US 2007/0204924 A1
(43) Pub. Date: Sep. 6, 2007

(54) VALVE

(75) Inventors: Gerard R. Delgiacco, Yonkers, NY (US); Mladen Franovic, Stamford, CT (US); Paul Kagan, Forest Hills, NY (US); Thomas J. Bormann, Huntington, NY (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 11/576,258

(22) PCT Filed: Oct. 13, 2005
(86) PCT No.: PCT/US05/36937

§ 371 Date: Mar. 29, 2007

Related U.S. Application Data
(60) Provisional application No. 60/622,610, filed on Oct. 28, 2004.

(51) Int. Cl. F16K 11/074

(52) U.S. Cl. 137/625.31

(57) ABSTRACT

A valve (600) comprising a housing (400) having first and second sections (100, 200) engaged together, wherein one section can rotated with respect to the other section from a position wherein fluid flow through the 101 housing is prevented, to a second position wherein fluid flow through the housing is allowed, is disclosed.

### CROSS-REFERENCE TO RELATED APPLICATIONS

This patent application claims the benefit of U.S. Provisional Patent Application No. 60/622,610, filed Oct. 28, 2004, which is incorporated by reference.

### BACKGROUND OF THE INVENTION

A variety of in-line devices are used to control fluid flow. Typically, the device comprises a housing with a valve disposed therein, wherein the valve includes a frangible portion that is broken when it is desired to allow fluid flow through the device.

These devices have suffered from a number of drawbacks. For example, the frangible portion may fail to break off completely, or, once broken off, can become lodged in an undesired location and restrict fluid flow. The frangible portion can adversely affect the fluid, e.g., if the fluid is a biological fluid, red blood cells contacting the portion can become hemolyzed and/or platelets contacting the portion can become activated. Alternatively, or additionally, red blood cells and/or platelets can aggregate upon contacting the portion. Some devices require the use of a tool to facilitate breaking the frangible portion. Additionally, or alternatively, the valves may have to be oriented in a specified direction (e.g., so that the frangible portion is arranged in the downstream direction) to be operated to allow fluid flow, thus requiring careful assembly of the devices.

The present invention provides for ameliorating at least some of the disadvantages of the prior art. These and other advantages of the present invention will be apparent from the description as set forth below.

### BRIEF SUMMARY OF THE INVENTION

In an embodiment of the invention a valve is provided comprising a housing comprising a first section and a second section; the first section comprising at least one inlet; the second section comprising at least one outlet; wherein the first section is rotatably engaged with the second section, and, while the sections are engaged, one section can be rotated with respect to the other section from a first position wherein fluid flow through the housing is prevented to a second position allowing fluid flow through the housing.

Another embodiment of a valve according to the invention comprises a housing comprising a first section and a second section; the first section comprising at least one inlet and at least one inlet fluid flow channel; the second section comprising at least one outlet and at least one outlet fluid flow channel; wherein the first section is rotatably engaged with the second section, and, while the sections are engaged, the first section is rotatable with respect to the second section from a first position that prevents fluid flow through the housing, to a second position that allows fluid flow through the housing.

In preferred embodiments, the valve includes a gasket interposed between the sections, wherein the gasket includes at least one opening that allows fluid flow therethrough when a section is rotated from the first position to the second position.

Alternatively, or additionally, in some embodiments the valve includes at least two inlets and/or at least two outlets.

In another embodiment, the valve comprises a housing comprising a first section and a second section; the first section comprising a first inlet and a second inlet, the second section comprising an outlet; optionally, a gasket interposed between the first section and the second section, the gasket including at least one opening for allowing fluid flow therethrough, wherein the first section is rotatably engaged with the second section, and, while the sections are engaged, one section can be rotated with respect to the other section from a first position wherein fluid flow through the housing is prevented to a second position allowing fluid flow through the housing. In a more preferred embodiment, the first section can be rotated to a plurality of second positions, the positions allowing fluid flow from the first inlet and through the outlet, fluid flow from the second inlet and through the outlet and/or allowing fluid flow from the first and second inlets and through the outlet.

In another embodiment, the invention provides a fluid processing device comprising at least one conduit communicating with a valve, the valve comprising a housing comprising a first section and a second section; the first section comprising at least one inlet; the second section comprising at least one outlet; wherein the first section is rotatably engaged with the second section, and, while the sections are engaged, one section can be rotated with respect to the other section from a first position wherein fluid flow through the housing is prevented to a second position allowing fluid flow through the housing. In some embodiments, the device comprises a first conduit connected to the first section of the housing, and a second conduit connected to the second section of the housing. In other embodiments, the device comprises a first conduit connected to the first section of the housing, and a fluid processing container having at least two fluid flow ports, wherein one fluid flow port of the fluid processing container connected to the second section of the housing.

In yet another embodiment, a fluid processing system is provided, comprising a fluid processing device as described above, and at least one fluid processing container comprising a flexible bag including at least two fluid flow ports, wherein the container is in fluid communication with the valve.

### BRIEF DESCRIPTION OF THE SEVERAL VIEWS OF THE DRAWING(S)

FIG. 1 is a cross-sectional view of an embodiment of a valve according to the present invention comprising first and second housing sections and a gasket. FIG. 1a shows an exploded view, FIG. 1b shows an assembled view, wherein the first housing section is in a first position with respect to the second housing section, which prevents flow through the valve, and FIG. 1c shows a top view of an embodiment of a gasket in the valve.

FIG. 2 shows a cross-sectional view of the embodiment of the valve shown in FIG. 1, wherein the first housing section is in a second position with respect to the second housing section, which allows flow through the valve.

FIG. 3 shows a cross-sectional view of the second section of the valve shown in FIG. 1, including a gasket sealed to the second section.

FIG. 4 shows a top view of the second section of the valve shown in FIG. 1a, also showing grooves for use in sealing the gasket to the second section and showing part of a locking arrangement.

FIG. 5 shows a top view of the second section of the valve shown in FIG. 4, also showing the gasket.

FIG. 6 shows a side view of the second section of the valve shown in FIG. 1a, showing part of a locking arrangement.

FIG. 7 shows a bottom view of the first section of the valve shown in FIG. 1a.

FIG. 8 (FIGS. 8a-8e) shows another embodiment of a gasket for use in an embodiment of a valve according to the invention. FIGS. 8b-8e also show a portion of the first section of the valve, illustrating adjusting the flow of fluid through the valve.

FIG. 9 (FIGS. 9a-9e) shows various views of another embodiment of a valve according to the present invention comprising first and second housing sections and a gasket, wherein the first section includes first and second inlets, and the second section includes a single outlet. FIG. 9a shows an exploded cross-sectional view, FIG. 9b shows, in an exploded view, the gasket and the gasket contacting surfaces of the first and second sections, FIGS. 9c, 9d, and 9e show assembled side, front, and rear cross-sectional views, respectively. FIG. 9d shows the valve wherein the first section is in a second position providing fluid flow paths between the first and second inlets and the outlet. FIG. 9e shows the valve wherein the first section is in a first position wherein the fluid flow paths are closed between the first and second inlets and the outlet.

FIG. 10 (FIGS. 10a-10d) shows various views of the gasket and a bottom portion of the first housing section of FIG. 9 illustrating allowing and preventing fluid flow through the valve between the first inlet and the outlet and/or between the second inlet and the outlet.

FIG. 11 shows an embodiment of a fluid processing device, including the assembled valve shown in FIG. 1b, with first and second conduits connected to the first and second sections of the housing, respectively.

FIG. 12 (FIGS. 12a-12b) shows various views of another embodiment of a fluid processing device, including the assembled valve shown in FIG. 9, with separate conduits connected to the first and second inlets of the first section of the housing, and an additional conduit connected to the outlet of the second section of the housing.

FIG. 13 shows various views of another embodiment of a valve according to the present invention comprising first and second housing sections and a gasket, wherein the first section includes first and second inlets, and the second section includes a single outlet, and wherein the valve is arranged such that the proportions of two different fluids passing through the valve can be adjusted. FIG. 13a shows a top view, FIG. 13b shows a cross-sectional view along line A-A, FIG. 13c shows a cross-sectional view along line B-B. FIGS. 13d-h show the gasket and the bottom portion of the first section of the valve, illustrating allowing and preventing flow through the valve between the first inlet and the outlet and/or between the second inlet and the outlet, as well as incrementally uncovering the ends of the fluid flow channels to change the flow of fluids through the valve.

FIG. 14 shows a cross-sectional view an embodiment of an assembled valve according to the invention without a gasket between the first and second housing sections.

FIG. 15 (FIGS. 15a-15b) shows cross-sectional views of another embodiment of an assembled valve according to the present invention comprising first and second housing sections, wherein the first section includes first and second inlets, and the second section includes a single outlet, and wherein the valve does not include a gasket between the first and second housing sections.

FIG. 16 is a cross-sectional view of another embodiment of an assembled valve according to the present invention, wherein the second section has been swaged for engagement with the first section.

FIG. 17 is a cross-sectional view of another embodiment of an assembled valve according to the present invention, wherein the sections have been engaged using an ultrasonic seal. FIG. 17a shows an embodiment without a gasket, and FIG. 17b shows an embodiment with a gasket.

FIG. 18 shows an embodiment of a fluid processing device, including the assembled valve shown in FIG. 1b, with a first conduit connected to the first section of the housing, and a fluid processing container, wherein a fluid flow port of the fluid processing container is connected to the second section of the housing.

FIG. 19 shows an embodiment of a biological fluid processing system including the biological fluid processing devices illustrated in FIGS. 11 and 18.

FIG. 20 shows an embodiment of a biological fluid processing system including the biological fluid processing devices illustrated in FIG. 12.

FIG. 21 shows an embodiment of a fluid processing device comprising a valve and a container, wherein the valve has indicia showing the direction of rotation of a housing section and indicia showing reference positions for different flow rates through the valve, allowing a user to adjust flow rates as desired.

FIG. 22 shows another embodiment of a system, comprising two valves as shown in FIG. 9, a vent communicating with each valve, a filter interposed between the valves, an upstream container, and a downstream container. FIG. 22 also shows various views of the gasket and a bottom portion of the first housing section of each valve illustrating allowing and preventing fluid flow through the valve between at least one inlet and/or at least one outlet.

### DETAILED DESCRIPTION OF THE INVENTION

In an embodiment, the invention provides a valve comprising a housing comprising a first section and a second section; the first section comprising at least one inlet; the second section comprising at least one outlet; wherein the first section is rotatably engaged with the second section, and, while the sections are engaged, one section can be rotated with respect to the other section from a first position wherein fluid flow through the housing is prevented to a second position allowing fluid flow through the housing. In one embodiment, the first section is rotatable with respect to the second section from a first position that prevents fluid flow through the housing, to a second position that allows fluid flow through the housing.

Another embodiment of a valve according to the invention comprises a housing comprising a first section and a second section; the first section comprising at least one inlet and at least one inlet fluid flow channel; the second section comprising at least one outlet and at least one outlet fluid flow channel; wherein the first section is rotatably engaged with the second section, and, while the sections are engaged, the first section is rotatable with respect to the second section from a first position that prevents fluid flow through the housing, to a second position that allows fluid flow through the housing.

In a preferred embodiment, the valve includes a gasket interposed between the sections, wherein the gasket includes at least one opening that allows fluid flow therethrough when a section is rotated from the first position to the second position.

Alternatively, or additionally, in some embodiments the valve includes at least two inlets and/or at least two outlets.

In another embodiment, the valve comprises a housing comprising a first section and a second section; the first section comprising a first inlet and a second inlet, the second section comprising an outlet; an optional gasket interposed between the first section and the second section, the gasket including at least one opening for allowing fluid flow therethrough, wherein the first section is rotatably engaged with the second section, and, while the sections are engaged, one section can be rotated with respect to the other section from a first position wherein fluid flow through the housing is prevented to a second position allowing fluid flow through the housing. In a more preferred embodiment, the first section can be rotated to a plurality of second positions, the positions allowing fluid flow from the first inlet and through the outlet, fluid flow from the second inlet and through the outlet and/or allowing fluid flow from the first and second inlets and through the outlet. In some embodiments, the proportions of two fluids passing through the valve can be adjusted as desired.

A fluid processing device according to another embodiment of the invention comprises an embodiment of the valve as described above, at least a first conduit connected to the first section of the housing, and a flexible container including two or more fluid flow ports, wherein one of the fluid flow ports is connected to the second section of the housing.

In an embodiment, the invention provides a fluid processing device comprising an embodiment of the valve as described above, at least one first conduit connected to the first section of the housing, and at least one second conduit connected to the second section of the housing. In some embodiments, the fluid processing device has at least two first conduits connected to the first section of the housing, and at least one second conduit connected to the second section of the housing, or at least one first conduit connected to the first section of the housing, and at least two second conduits connected to the second section of the housing.

An embodiment of a biological fluid processing system is also provided, comprising a fluid processing device including at least one first conduit and at least one second conduit as described above, and a first biological fluid processing container comprising a flexible bag including at least two fluid flow ports, wherein one of the conduits is in fluid communication with one of the fluid flow ports. The biological fluid processing system can include at least one additional container, e.g., a flexible bag including at least one fluid flow port, wherein the additional (e.g., second) bag is in fluid communication with the other conduit. Alternatively, or additionally, embodiments of the biological fluid processing system can include additional containers, e.g., wherein the containers are downstream of, and in fluid communication with, the first or second bags.

In yet another embodiment, a biological fluid processing system is provided, comprising a fluid processing device as described above, and at least one additional biological fluid processing container comprising a flexible bag including at least two fluid flow ports.

Embodiments of fluid processing devices and/or systems can include two or more conduits, two or more bags, and/or two or more valves.

Advantageously, the valve can be operated to allow fluid flow when desired without breaking a frangible portion, and thus, there is no frangible portion in the fluid flow path that could adversely affect fluid flow and/or adversely affect the biological fluid components in the fluid being processed in accordance with embodiments of the invention. The valve can be operated without special tools. Also advantageously, the valve includes smooth rounded surfaces and edges where the biological fluid contacts the valve, further minimizing the potential to stress the biological fluid components. In accordance with another advantage, the valve can be oriented in any direction with respect to fluid flow, e.g., either end can be “upstream” or “downstream.”

Yet another advantage is that, if desired, the valve can be operated (e.g., in a biological fluid processing system) such that fluid flow can be started and/or stopped without clamping and unclamping one or more conduits communicating with the valve. Avoiding clamping can be advantageous in that clamping can damage one or more components in the fluid present in the conduit(s) and/or clamping and unclamping can be labor intensive. This can be especially desirable in some embodiments wherein the valve includes more than one inlet and/or more than one outlet, as the valve can be operated (e.g., as a “Y” or “T” connector) to provide combined or separated fluid flow paths, without clamping and unclamping the conduit(s) communicating with the valve.

Avoiding clamping can also be advantageous in that clamped conduits can take a “set,” e.g., wherein the conduit does not return to its initial full open flow position and/or the clamp (e.g., a roller clamp) can “creep” such that the clamping force changes, allowing changes in the flow rate.

In accordance with another advantage, the flow rate through the valve can be readily adjusted and/or controlled, if desired.

In accordance with the invention, one or more fluid flow paths, e.g., one or more liquid flow paths, can be established through the engaged sections once one of the sections has been rotated, allowing fluid(s) to flow through the valve, wherein the fluid flow path(s) is/are isolated from the ambient environment and from contaminants present in the ambient environment. In some embodiments, the fluid flow path(s) can be established while maintaining a sterile fluid pathway, making the invention suitable for use in closed systems.

Embodiments of the invention are suitable for use with a variety of fluids, preferably, biological fluids.

Biological Fluid. A biological fluid includes any treated or untreated fluid associated with living organisms, particularly blood, including whole blood, warm or cold blood, and stored or fresh blood; treated blood, such as blood diluted with at least one physiological solution, including but not limited to saline, nutrient, and/or anticoagulant solutions; blood components, such as platelet concentrate (PC), platelet-rich plasma (PRP), platelet-poor plasma (PPP), platelet-free plasma, plasma, fresh frozen plasma (FFP), components obtained from plasma, packed red cells (PRC), transition zone material or buffy coat (BC); blood products derived from blood or a blood component or derived from bone marrow; stem cells; red cells separated from plasma and resuspended in physiological fluid or a cryoprotective fluid; and platelets separated from plasma and resuspended in physiological fluid or a cryoprotective fluid. The biological fluid may have been treated to remove some of the leukocytes before being processed according to the invention. As used herein, blood product or biological fluid refers to the components described above, and to similar blood products or biological fluids obtained by other means and with similar properties.

A “unit” is the quantity of biological fluid from a donor or derived from one unit of whole blood. It may also refer to the quantity drawn during a single donation. Typically, the volume of a unit varies, the amount differing from patient to patient and from donation to donation. Multiple units of some blood components, particularly platelets and buffy coat, may be pooled or combined, typically by combining four or more units.

As used herein, the term “closed” refers to a system that allows the collection and processing (and, if desired, the manipulation, e.g., separation of portions, separation into components, filtration, storage, and preservation) of biological fluid, e.g., donor blood, blood samples, and/or blood components, without the need to compromise the sterile integrity of the system. A closed system can be as originally made, or result from the connection of system components using what are known as “sterile docking” devices. Illustrative sterile docking devices are disclosed in U.S. Pat. Nos. 4,507,119, 4,737,214, and 4,913,756.

Each of the components of the invention will now be described in more detail below, wherein like components have like reference numbers.

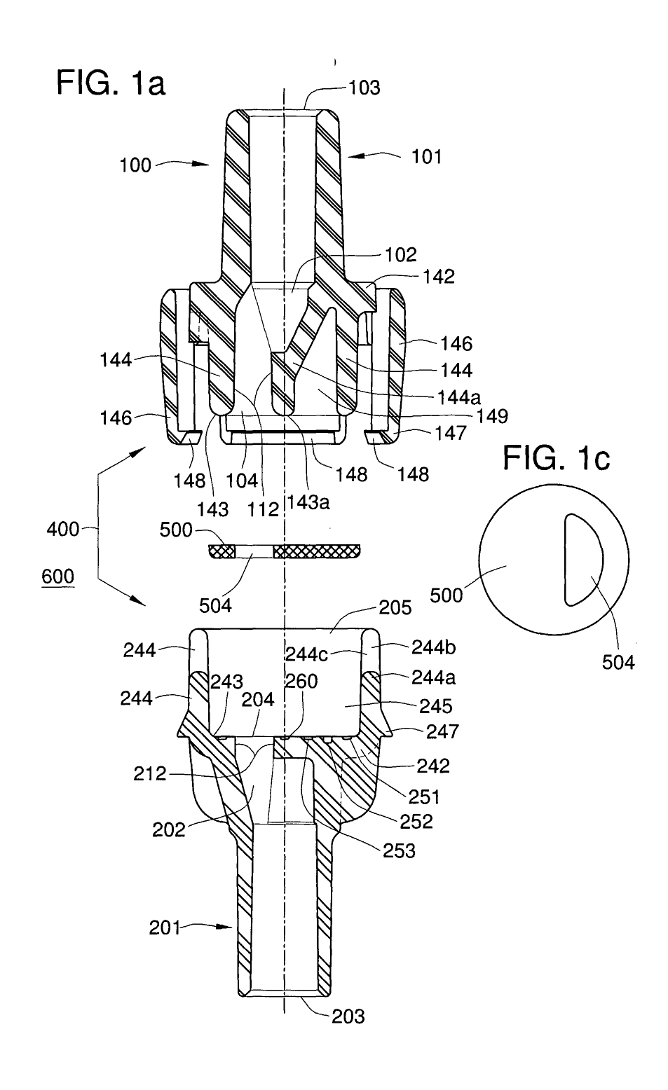

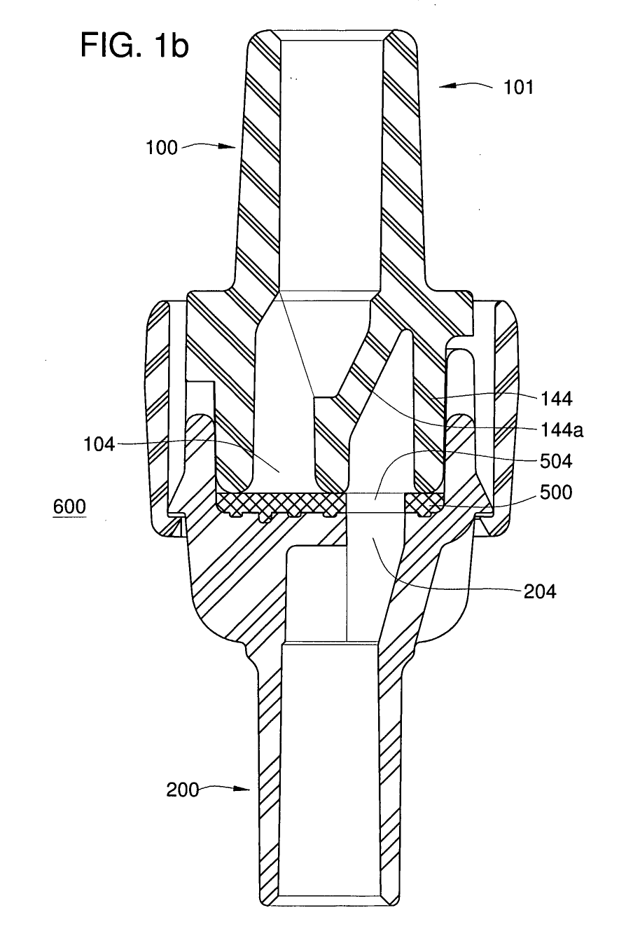

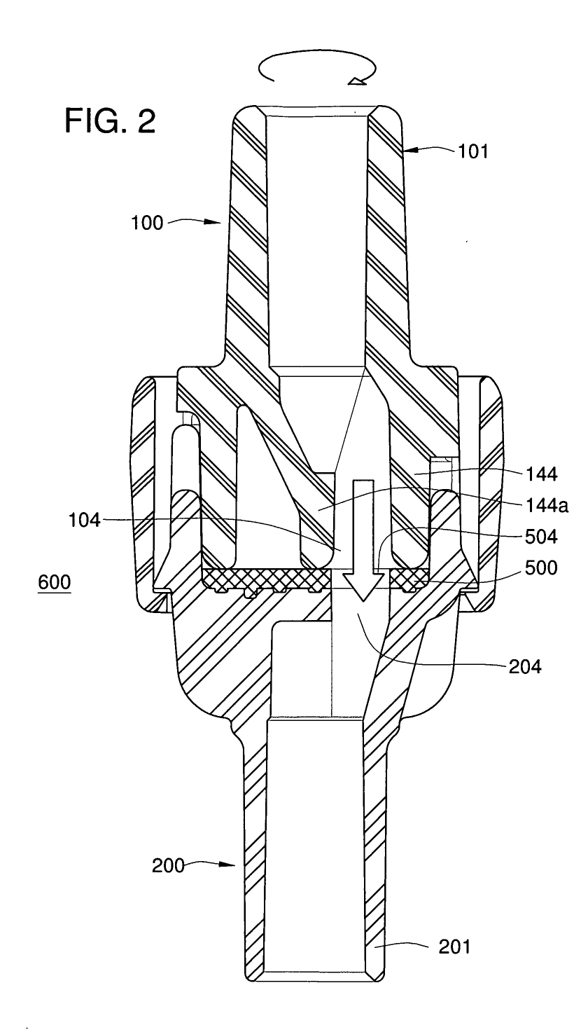

FIG. 1a shows an exploded cross-sectional view of a valve 600 according to an embodiment of the invention, comprising a housing 400 comprising a first section 100 and a second section 200, wherein, once assembled as shown in FIGS. 1b and 2, the sections are rotatably engaged together.

The housing and sections can be fabricated from any suitable impervious material or materials (e.g., rigid, semi-rigid, and/or elastic impervious material(s)), including any impervious thermoplastic material, which is compatible with the fluid, preferably, biological fluid, being processed. The housing and sections are preferably formed from a polymeric material, e.g., molded from a polymeric material such as an acrylic, polypropylene, polystyrene, or a polycarbonated resin. The housing and sections can be formed from a plurality of materials (e.g., one section can be formed from a different material or combinations of materials than another section). For example, one section can be formed from a rigid material, and another section can be formed from a semi-rigid or elastic material. Alternatively, or additionally, a section can have, for example, a portion formed from a rigid material, and another portion formed from a semi-rigid or elastic material.

In some embodiments, the housing and sections (or portions thereof) are formed from a transparent or translucent polymer, e.g., to allow observation of the passage of the fluid through the housing. Typically, the first and second sections are each single-piece sections, although in some embodiments, at least one section comprises two or more pieces.

In the embodiment shown in FIGS. 1a and 1b, the first section 100 includes an inlet 101, and a channel or aperture 102 (having open ends 103 and 104, the channel being formed by side wall 112), and second section 200 includes an outlet 201, and a channel or aperture 202 (having open ends 203 and 204, the channel being formed by side wall 212), and a gasket 500 including at least one cut-out or opening 504 is interposed between the channels 102 and 202. In this illustrated embodiment, the open ends in each channel are offset from one another, i.e., open end 103 is offset from open end 104, and open end 203 is offset from open end 204.

One section can be rotated independently of the other section while the sections remained engaged, preferably one section can be rotated with respect to the other section (e.g., one section rotates while the other remains stationary) from a first position wherein fluid flow through the housing is prevented, to at least a second position wherein fluid flow through the housing is allowed (e.g., using FIG. 2 for reference, wherein the three openings 104, 504, and 204 are at least partially aligned to allow fluid flow therethrough).

For directional orientation in the following discussion, each section has a proximal end, nearest the opposing section, and a distal end, furthest from the opposing section. Also, since the exemplary sections 100, 200 in the Figures comprise elongated bodies, the term axial denotes disposition along their axes.

In one embodiment, e.g., as shown in FIGS. 1a and 1b (cross-sectional view) and FIG. 7 (bottom view), the valve 600 comprises a housing 400 comprising first section 100 and second section 200, wherein the first section 100 comprises a first inlet 101 and a sidewall 112 providing a channel 102 having open ends 103 and 104. The first section also comprises a flange 142 (the flange typically assuming a radially extending annular plan form) and a sidewall 144 extending from the flange. In the illustrated embodiment, an additional side wall 144a also extends from the flange 142. A portion of sidewalls 144 and sidewall 144a is continuous with channel sidewall 112, and provides channel open end 104. The opening 104 can have a variety of shapes, and in one embodiment, as described below, the opening is generally “D” shaped.

The sidewall 144 includes a proximal end surface 143 (preferably, wherein the surface is rounded) facing the second section 200, and, in the this illustrated embodiment, which includes an additional sidewall 144a, the sidewall 144a includes a proximal end surface 143a (preferably, wherein the surface is rounded) and there is a space 149 between additional sidewall 144a and the portion of the sidewall 144 not providing channel sidewall 112. In another illustrative embodiment (not shown) there is no space 149 and no additional sidewall 144a, e.g., the sidewall 144 fills the area shown in FIG. 1a as space 149, and sidewall 144 provides channel sidewall 112.

In some embodiments, two or more forks 146 extend from the flange 142. The fork(s) can be formed integrally with the flange 142. Additionally, in the embodiment illustrated in FIG. 7, the first section also includes a projection or tooth 190.

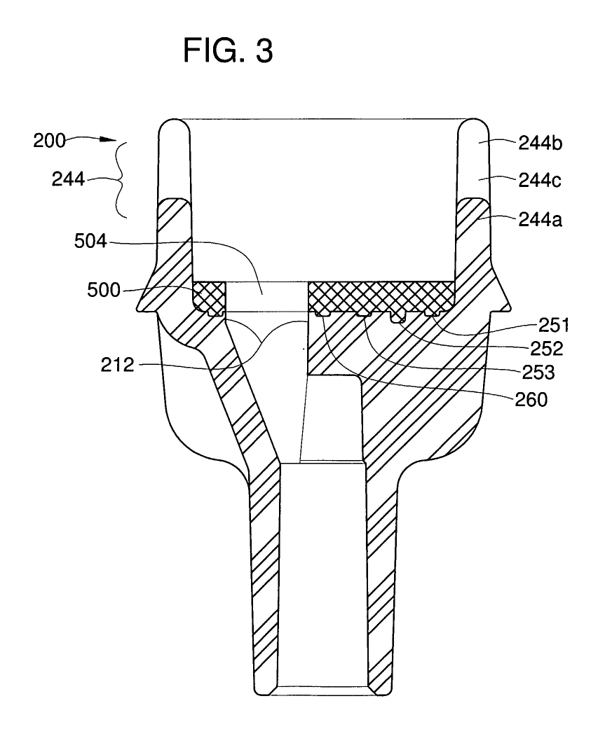

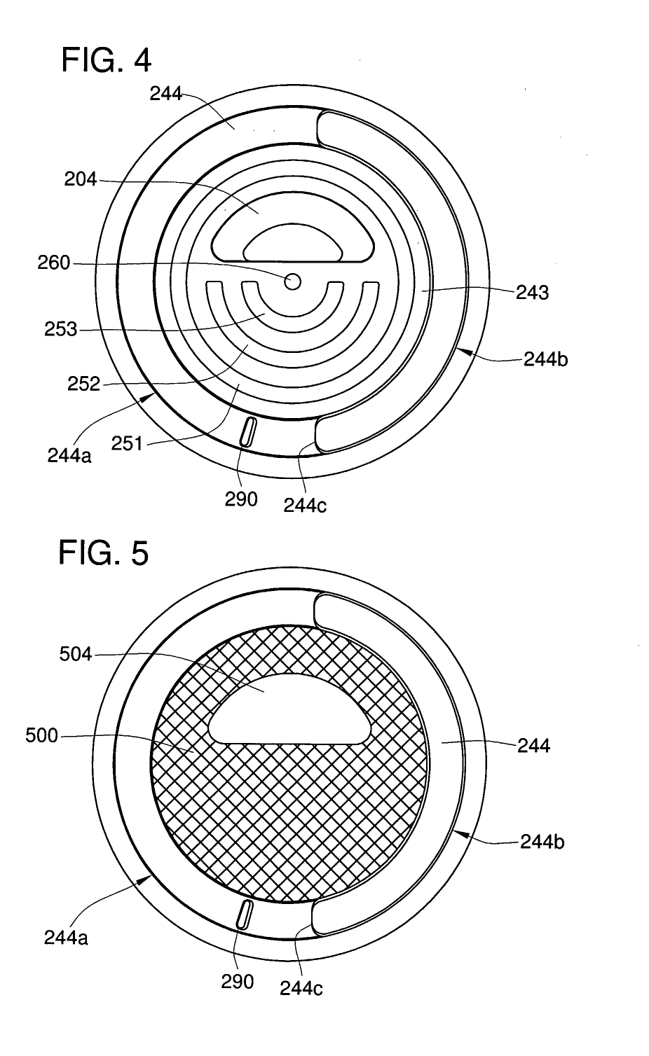

In one preferred embodiment, e.g., as shown in FIGS. 1a, 1b, 3 (cross-sectional view), as well as FIGS. 4 and 5 (bottom view), the second section 200 comprises a first outlet 201, a sidewall 212 providing a channel 202, having open ends 203 and 204, a flange 242 (the flange typically assuming a radially extending annular plan form) and a generally cylindrical sidewall 244 defining a socket or cup 245, wherein the second section has a proximal open end 205, and the base of the cup includes channel proximal open end 204. The open end 204 can have a variety of shapes, and in one embodiment, as described below, the opening is generally “D” shaped.

Preferably, in those embodiments wherein the valve includes a gasket, the base of the cup includes at least one rib, groove and/or blind hole, and FIGS. 1a, 3, and 4, show blind hole 260 and three grooves 251, 252, and 253, wherein groove 251 is annular, and the other two grooves 252 and 253 are approximately semicircular.

In embodiment illustrated in FIGS. 1-7, the sidewall 244 extends from and is concentric with the flange 242 and the second section includes an annular proximal end surface 243 facing the first section 100. Preferably, at least one lip or ridge 247 extends from the flange 242. The lip(s) can be formed integrally with the flange 242.

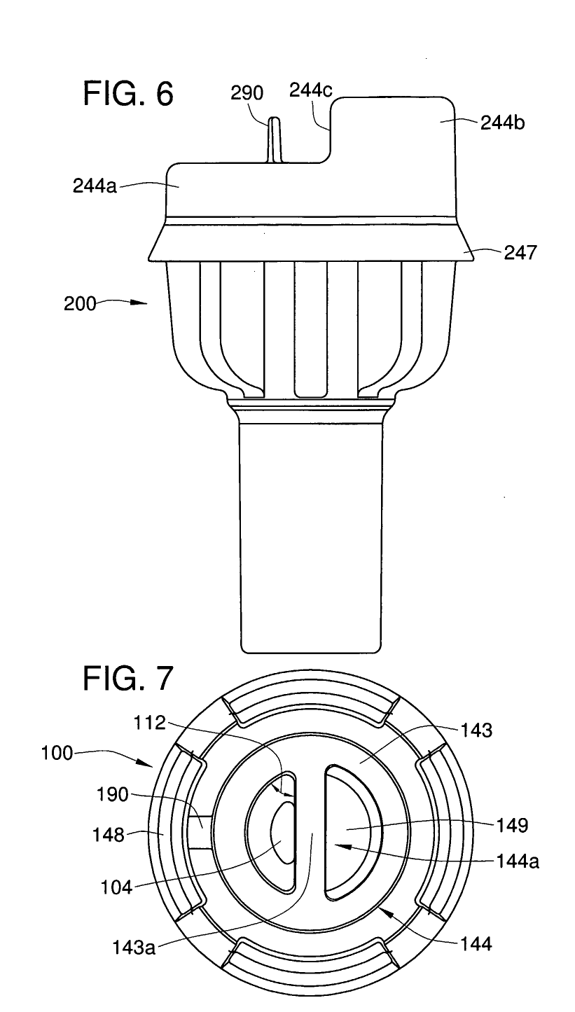

In one illustrated embodiment (e.g., as shown in FIG. 3 (side cross-section), FIG. 4 (top view) and FIG. 6 (side view)), a portion of the sidewall 244 is cut away to provide a lower sidewall 244a and a generally semicircular upper sidewall 244b. Additionally, in this illustrated embodiment, the second section also includes a projection or finger 290.

In this illustrated embodiment, wherein the valve includes a gasket 500, the gasket is enclosed in the socket 245 formed in the proximal open end 205 of second section 200. In the illustrated embodiment, the socket 245 is defined by the annular sidewall 244 and end surface 243, and preferably, the socket 245 completely surrounds the gasket 500, e.g., the sidewall 244 can comprise a continuous, unbroken cylindrical wall which completely surrounds the gasket 500.

The gasket 500 can be sealed to the first section 100 or the second section 200. Preferably, the gasket 500 is sealed to the second section 200 such that the gasket does not move independently of the second section. In one preferred embodiment, the gasket is insert molded or “two-shot” molded into the second section, more preferably, wherein the second section is still at an increased temperature from molding when the gasket is molded therein. This provides for an efficient thermal bond between the gasket and the second section. However, in some embodiments, an efficient thermal bond can be formed between the gasket and second section when the gasket is molded into a cooled second section. Alternatively, or additionally, the gasket can be sealed within the valve (e.g., within the second section), utilizing, for example, an adhesive, a solvent, radio frequency sealing, ultrasonic sealing and/or heat sealing and/or the gasket can be sealed via, for example, injection molding, or overmolding of the section.

In some embodiments wherein the valve includes a gasket, the second section includes one or more blind holes, ribs and/or grooves (e.g., as shown in FIGS. 3 and 4), to increase the surface area of the second section contacting the gasket during molding, preferably to improve the grip between the gasket and the cup.

The gasket 500 is preferably resilient, and a variety of suitable materials are known in the art. Exemplary materials for the gasket include resiliently compressible and expandable polymeric materials or elastomeric materials. Examples of suitable materials include, but are not limited to, silicone, and a TPE (thermoplastic elastomer), such as a Santoprene® TPE. The enhanced resiliency of the gasket provides a greatly improved seal.

Once the first and second sections are engaged together as described below, the gasket 500 is compressed between the end surface 243 of the second section 200 and the end surface 143 of the first section and the gasket is sealed between the first and second sections.

Preferably, the outer diameter of sidewall 144 is slightly larger than the inner diameter of sidewall 244 to provide a tight frictional fit when the first and second sections are engaged together.

When the first section 100 is engaged with the second section 200, the forks 146 engage with the flange 242. Each fork 146 preferably comprises at least one prong 147 wherein the prong is preferably flexible to allow the prong to slide along the slide wall 244 of the flange 242 and engage the flange. One or more catches 148 can be formed on the prongs 147 and abut a distal surface of the flange 242. In this manner, the forks 146 engage the flange 242 to interlock the first and second sections together, preferably via the one or more catches 148 engaging one or more lips 247. Alternatively, for example, the sections can be engaged using forks engaging with slots. In accordance with embodiments of the invention, the first and second sections can be engaged together via a variety of other arrangements. For example, other embodiments of the invention, the first and second sections are engaged together without including the forks and flanges as described above. Illustratively, the sections can be ultrasonically sealed together, or swaged together.

FIGS. 1b and 2 show cross-sectional views of an embodiment of an assembled valve 600, wherein FIG. 1b shows the first section in a first position (with respect to the second section) preventing fluid flow through the housing, and FIG. 2 shows the first section in a second position allowing fluid flow through the housing.

In accordance with this illustrated embodiment, when the first section is rotated circumferentially on its axis from the first position, open end 104 moves toward the cut-out 504 of gasket 500, wherein cut-out 504 is aligned with open end 204 of the second section 101. Accordingly, when the first section is in the second position, the cut-out 504, which is aligned with open end 204, is also aligned with open end 104 of the first section. In accordance with the embodiment shown in FIG. 2, when the distal open end 104 of channel 101 in the first section and the distal open end 204 of channel 201 in the second section align with the opening 504 in the gasket 500, fluid can flow through the valve from the inlet 101 through the outlet 201.

Preferably, the flow rate and/or flow paths through the valve are controlled by the relative positioning of the first and second sections. However, in those embodiments including a gasket, the gasket 500 can include more than one opening 504 and/or the opening can be configured (e.g., by controlling the size and/or shape of the opening) so that different flow rates and/or flow paths can be provided when the rotated section is in a second position, or in any additional position that is not the first position. Additionally, or alternatively, the housing can be configured so that different flow rates and/or flow paths can be provided when a section is in a second position, or in any additional position that is not the first position. If desired, in some embodiments, the second position can include a number of degrees of rotation for the rotating section, wherein the openings 104, 504 and 204 can be partially or completely aligned, to provide a desired flow rate and/or flow path.

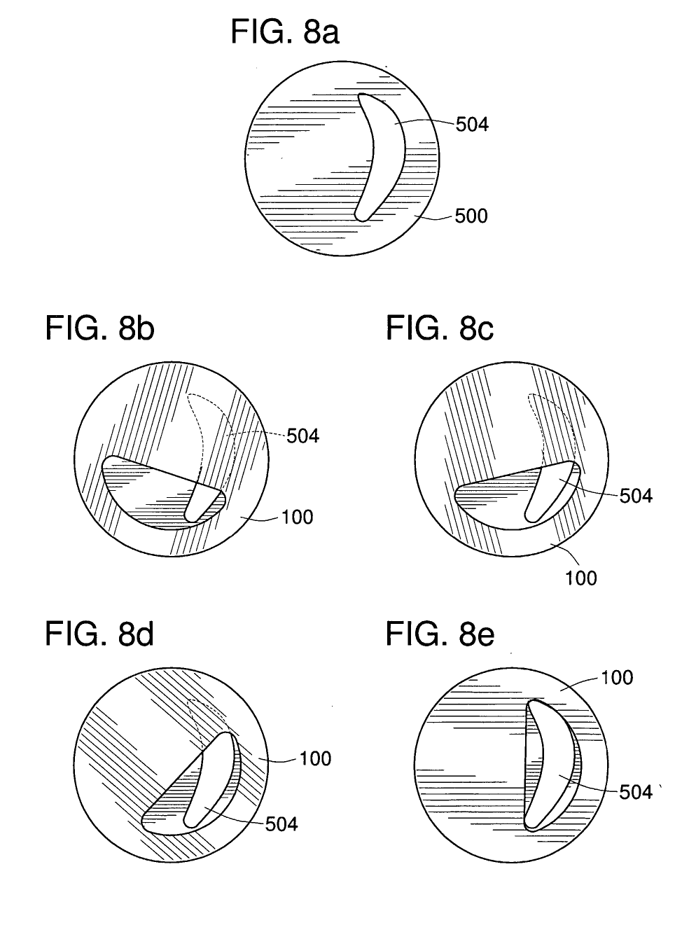

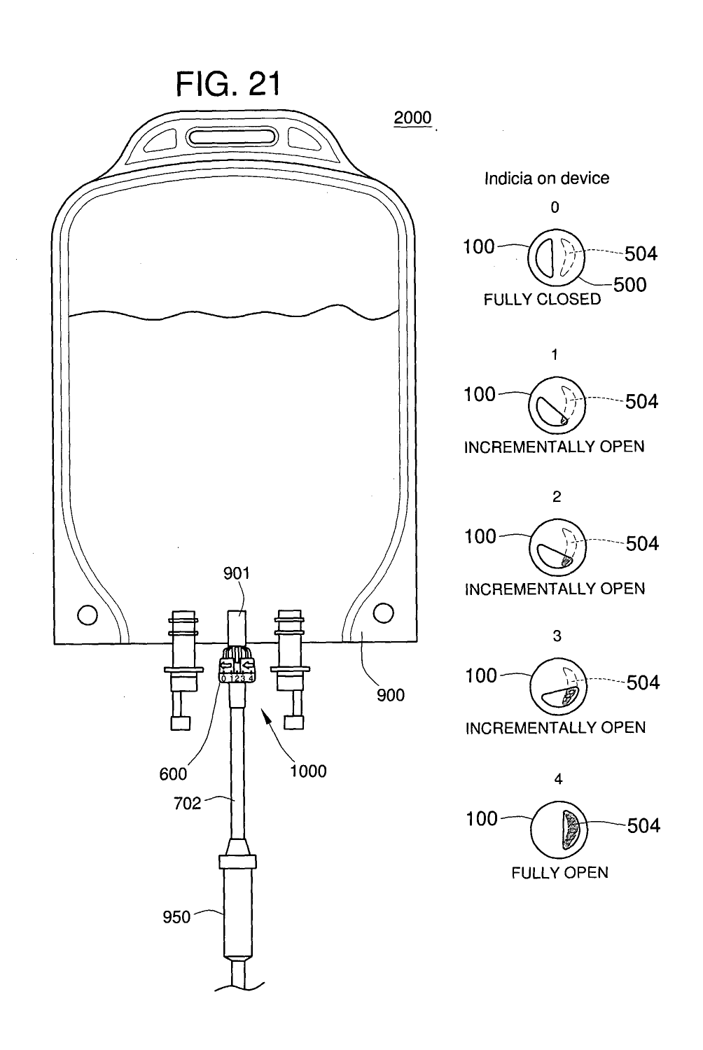

Illustratively, FIG. 8 shows another embodiment of the gasket 500 having a crescent-shaped opening 504, wherein the gasket includes a differently shaped opening than the gasket illustrated in FIG. 1a. FIG. 8 also illustrates how different flow rates and/or flow volumes can be obtained when a first section moves along various degrees of rotation in the second position. For example, FIGS. 8b-8e show, respectively, about 25% of the area of the opening 504 being uncovered, about 50% of the area being uncovered, about 75% of the area being uncovered, and 100% of the area being uncovered. In some embodiments, the flow rate and/or flow volume can be changed to more efficiently drain an upstream container and/or to more efficiently combine or mix fluids. For example, as shown in FIG. 21, the flow rate can be changed to more efficiently administer one or more fluids to a patient, wherein the flow rate (e.g., as monitored by a drip chamber 950) is changed as desired.

The opening(s) and housing can be configured so that the change in flow is proportional, or non-proportional, to the area of the opening being uncovered and/or the degrees of rotation traveled by the rotating section. Gasket 500 shown in FIGS. 1a and 1c, and gaskets having other configurations of one or more openings (e.g., wherein different openings in the same gasket can have different configurations), can also be utilized in a similar manner.

In accordance with embodiments of the invention, the valve can, if desired, provide for any desired flow volume and/or flow rate. In some embodiments, the valve can provide for more than one calibrated flow volume and/or flow rate.

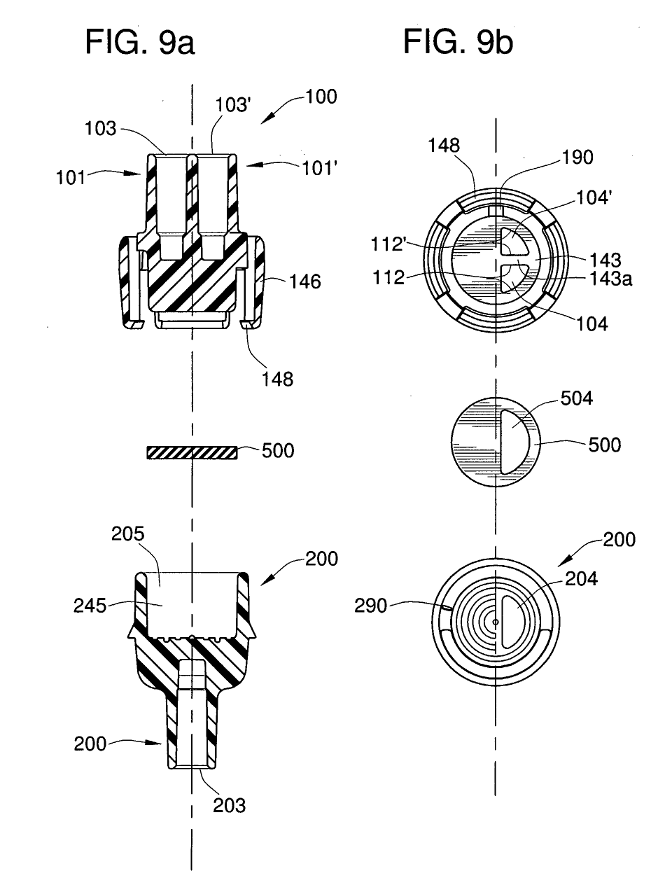

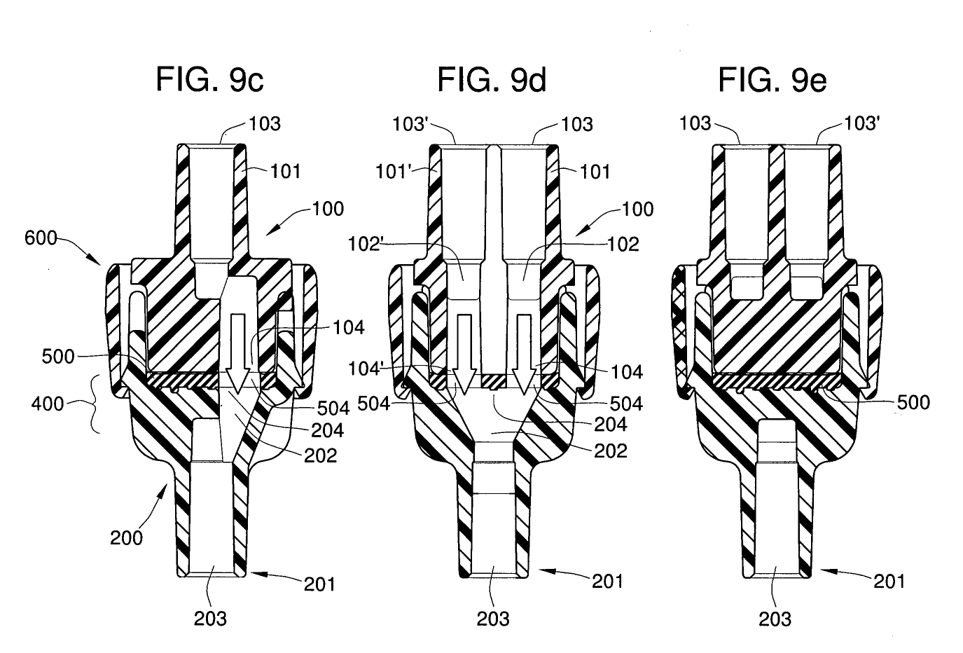

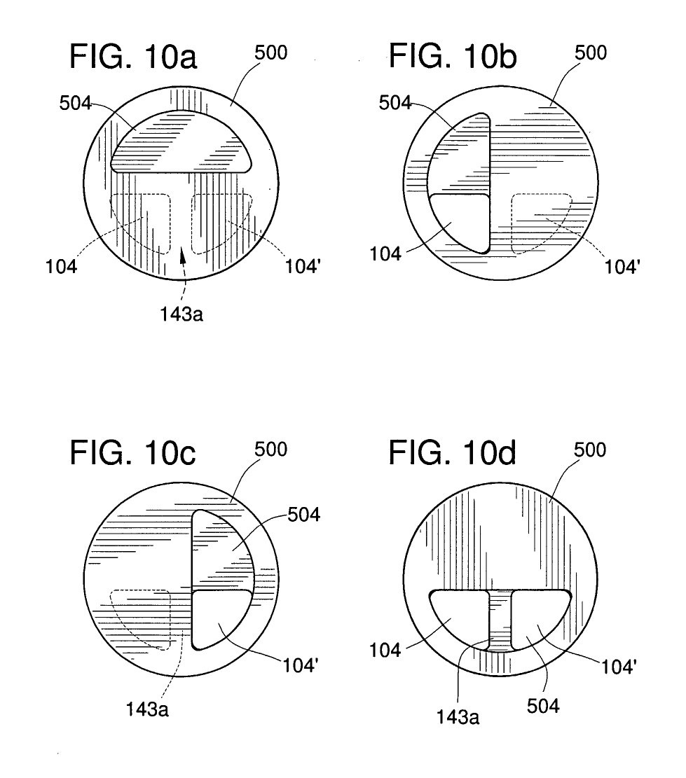

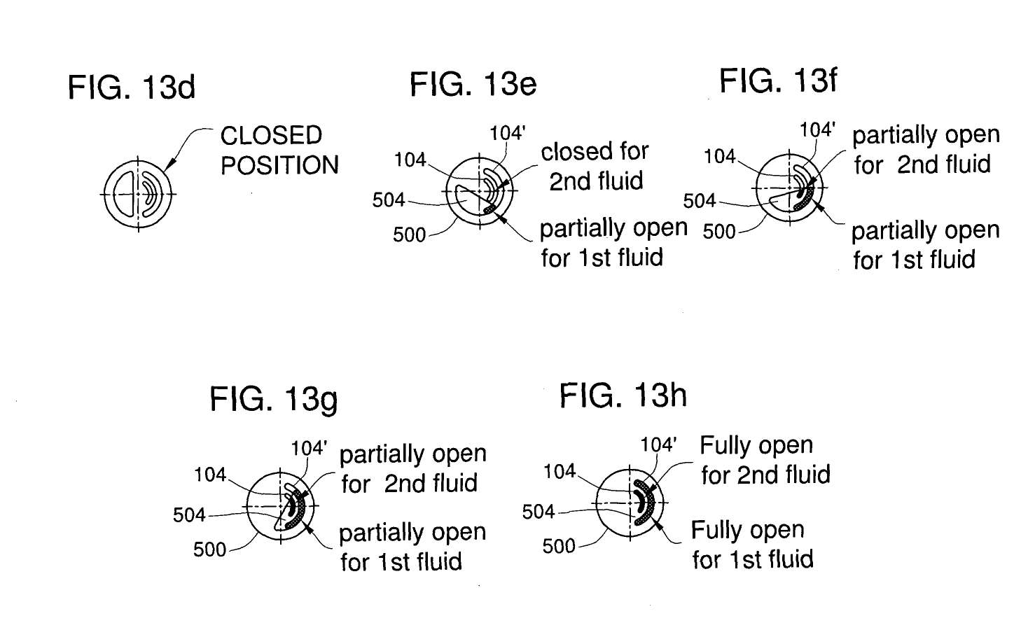

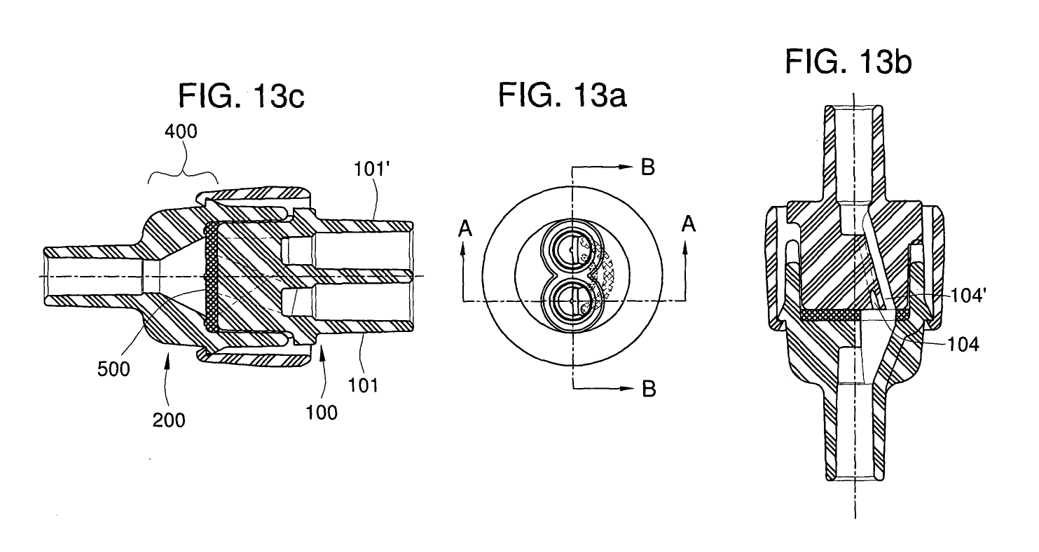

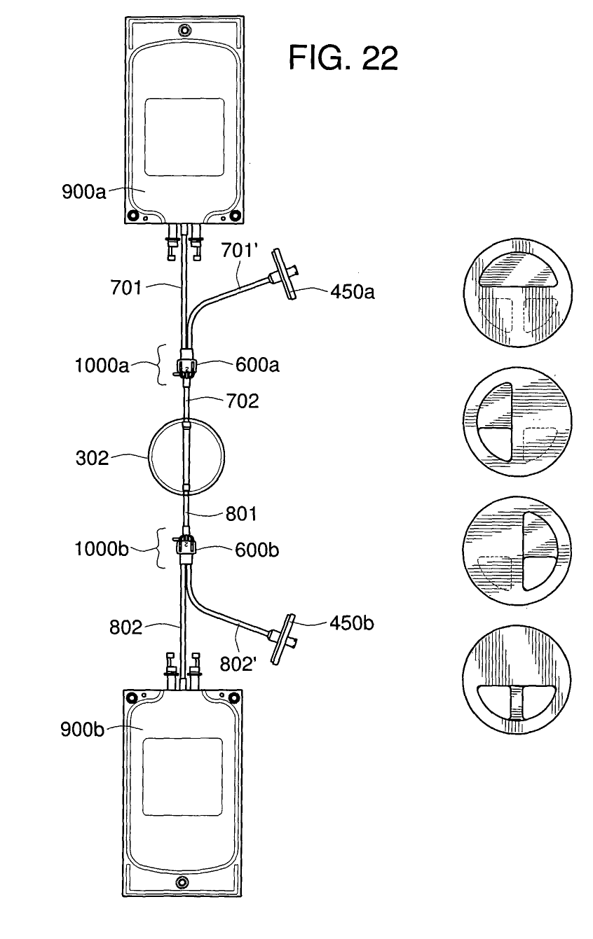

A gasket can have a plurality of openings for use in providing a plurality of fluid flow paths. Alternatively, or additionally, a single opening in a gasket can be utilized in a valve providing a plurality of fluid flow paths. For example, as will be described in more detail below, FIGS. 9 and 13 shows embodiments of valves, and FIG. 10 shows an embodiment of a gasket used in the valve shown in FIG. 9 (particularly shown in FIG. 9b), wherein different flow paths are provided when the first housing section 100 is in positions other than the first position (e.g., the section can rotated to a plurality of second positions). As will also be shown below, FIG. 22 shows valves also including an embodiment of a gasket used in the valve shown in FIGS. 9 and 13, wherein different flow paths are provided through the valves shown in FIG. 22 when the first housing section 100 is in positions other than the first position.

While FIGS. 1c, 8, 10, and 21 show gaskets having “D-shaped” or crescent-shaped openings, one of ordinary skill in the art will recognize a variety of other shaped openings can be used in accordance with the invention.

As will be discussed in more detail below, in those embodiments wherein the valve includes two or more inlets and/or two or more outlets (e.g., FIGS. 9 and 13 illustrate embodiments of valves including two inlets and a single outlet), as well as a gasket, the gasket can include one or more openings wherein the valve can be operated to provide one or more flow paths. For example, using FIG. 9 with 10, and FIG. 13, for reference, the valve can be operated to provide a first fluid flow path from a first inlet through a gasket opening and through an outlet, a second fluid flow path from a second inlet through a gasket opening and through the outlet, and/or combined first and second fluid flow paths through the device wherein fluid flows through the first inlet and through the outlet while fluid flows through the second inlet and the outlet. In these illustrated embodiments, the first and second fluid flow paths flow through the same opening in the gasket. However, in other embodiments, the first and second fluid flow paths flow through separate openings in the gasket.

In the embodiment illustrated in FIG. 9, the valve 600 comprises a housing 400 comprising first section 100 and second section 200. The illustrated first and second sections have some similarities to the first and sections illustrated in FIG. 1. However, in accordance with the embodiment illustrated in FIG. 9, the device can be operated to provide first and second fluid flow paths, and the first section 100 comprises a first inlet 101 and a sidewall 112 providing a first channel 102 having first open ends 103 and 104, and a second inlet 101′ and a sidewall 112′ providing an additional first channel 102′ having open ends 103′ and 104′. The channels can have a variety of configurations and the open ends can have a variety of shapes.

The first section illustrated in FIG. 9 also comprises a flange 142 (the flange typically assuming a radially extending annular plan form) and a sidewall 144 extending from the flange. In the illustrated embodiment, an additional side wall 144a also extends from the flange 142. A portion of sidewalls 144 and sidewall 144a is continuous with channel sidewall 112, and provides channel open end 104, and another portion of sidewalls 144 and sidewall 144a is continuous with channel sidewall 112′, and provides channel open end 104′. The openings 104 and 104′ can have a variety of shapes, and one opening can have a different shape than the other opening.

The sidewall 144 includes a proximal end surface 143 (preferably, wherein the surface is rounded) facing the second section 200, and, in this illustrated embodiment, which includes an additional sidewall 144a, the sidewall 144a includes a proximal end surface 143a (preferably, wherein the surface is rounded). Typically, two or more forks 146 extend from the flange 142, and the illustrated embodiment includes four forks. The fork(s) can be formed integrally with the flange 142.

In the embodiment illustrated in FIG. 9, the second section 200 and gasket 500 correspond to the second section and gasket as described with respect to FIG. 1, and the sections are engaged together, with the gasket therebetween, as described above.

Using FIGS. 9 and 10 for reference, when the first section is rotated circumferentially on its axis from the first position, the first section is rotated so that, as desired, the open end 104 moves toward the cut-out 504 of gasket 500, wherein cut-out 504 is aligned with open end 204 of the second section 200 and/or the open end 104′ moves toward the cut-out 504 of gasket 500, wherein cut-out 504 is aligned with open end 204 of the second section 201.

Illustratively, when the first section is in the first position, openings 104 and 104′ in the first section 100 are covered by the non-open section of gasket 500, as shown in FIG. 10a. When the first section is in one of the second positions (e.g., the “first” second position), the cut-out 504, which is aligned with open end 204, is also aligned with open end 104 of the first section, but not open end 104″, as shown in FIG. 10b. When the first section is in one of the additional second positions (e.g., the “second” second position), the cut-out 504, which is aligned with open end 204, is also aligned with open end 104′ of the first section, but not open end 104, as shown in FIG. 10c. When the first section is in another additional second position (e.g., the “third” second position), the cut-out 504, which is aligned with open end 204, is also aligned with open ends 104 and 104′ of the first section, as shown in FIG. 10d.

Thus, when the distal open end 104 of channel 102 in the first section and the distal open end 204 of channel 202 in the second section align with the opening 504 in the gasket 500, fluid can flow along a first fluid flow path through the valve from the first inlet 101 through the outlet 201. When the distal open end 104′ of channel 102′ in the first section and the distal open end 204 of channel 202 in the second section align with the opening 504 in the gasket 500, fluid can flow along a second fluid flow path through the valve from the second inlet 101′ through the outlet 201.

When the distal open end 104 of channel 102, the distal open end 104′ of channel 102′, and the distal open end 204 of channel 202, all align with the opening 504 in the gasket 500, fluid can flow along the first and second fluid flow paths through the valve from the first and second inlets 101 and 101′ through the outlet 201, as shown in FIGS. 9d and 10c. If desired, the first section can be rotated to incrementally engage the fluid flow channels, e.g., by varying the area of the ends of the channels that are available to allow fluids to flow therethrough. Any desired engagement can be provided.

FIG. 13 illustrates another embodiment of a valve allowing the flow rates of fluids passing through the valve to be adjusted as desired.

In the embodiment illustrated in FIG. 13, the valve 600 comprises a housing 400 comprising first section 100 and second section 200, and the illustrated first and second sections are generally similar to the first and sections illustrated in FIG. 9. However, in accordance with the embodiment illustrated in FIG. 13, the first channel 102 and additional first channel 102′ are arranged differently in the first section 100 than the channels in FIG. 9. Additionally, the open ends 104 and 104′ in FIG. 13 are arranged differently than the open ends 104 and 104′ in FIG. 9. The illustrated open ends 104 and 104′ in FIG. 13 generally subtend the same angle, and are preferably radially spaced. The illustrated open ends are curved, preferably, arcuate. However, in other embodiments, the open ends can have a variety of shapes and orientations.

With respect to changing the flow of fluids passing through the valve, FIG. 13 shows varying the engagement of the fluid flow channels to allow fluids to pass through the valve. FIGS. 13d-13h show, sequentially, the first section 100 in the first position, wherein the open ends 104 and 104′ in the first section 100 are covered by the non-open section of gasket 500 (FIG. 13d); the first section in one of the second positions (e.g., the “first” second position), wherein the cut-out 504, which is aligned with open end 204, is also partially aligned with open end 104 of the first section (uncovering a portion of the area of the open end 104 and allowing fluid flow through the first fluid flow path), but not open end 104″ (uncovering 0% of the area of the open end 104′ and not allowing flow through the second fluid flow path) (FIG. 13e); the first section in the “second” second position, wherein the cut-out 504, which is aligned with open end 204, is partially aligned with open end 104 of the first section (uncovering a greater portion of the area of open end 104), and partially aligned with open end 104″ (uncovering a portion of the area of open end 104′) (FIG. 13f); the first section in the “third” second position, wherein the cut-out 504, which is aligned with open end 204, is partially aligned with open end 104 of the first section (uncovering a greater portion of the area of open end 104), and partially aligned with open end 104′ (uncovering a greater portion of the area of open end 104′) (FIG. 13g); and the first section in the “fourth” second position, wherein the cut-out 504, which is aligned with open end 204, is aligned with open end 104 of the first section (fully uncovering the area of open end 104), and aligned with open end 104″ (fully uncovering the area of open end 104′) (FIG. 13h).

As a result, the valve can be used as a multi-way connector, for example, a Y- or T-connector and/or can be used to maintain separate flow paths (e.g., separating a fluid flow path from a first inlet to an outlet from a fluid flow path from a second inlet to an outlet, or separating a fluid flow path from an inlet to a first outlet from a fluid flow path from an inlet to a second outlet).

For example, the first fluid flow path can be used to pass a first fluid, e.g., a drug, or a priming fluid such as saline to prime a filter device downstream of the valve, and the second fluid flow path can be used to pass a second fluid, e.g., a biological fluid to be passed through the primed filter. The first and second fluids can be the same, or different. Alternatively, for example, one inlet can be placed in fluid communication with a vent such as a gas inlet (e.g., wherein the gas inlet includes a membrane that allows gas to pass therethrough), the other inlet can be placed in communication with a container of biological fluid, and the outlet can be placed in communication with a biological fluid filter and/or a container for containing processed biological fluid. The valve can be operated so that first fluid flow path is used to pass one fluid, e.g., a biological fluid that can be passed to the biological fluid filter. After the flow of biological fluid stops, and fluid remains in a conduit upstream of the filter and/or in the filter housing, the valve can be operated so that the second fluid flow path is open for flow, so that gas passes through the gas inlet, and held up biological fluid can be displaced and recovered. Thus, it is possible there is no need to utilize the valve in a position wherein the first and second flow paths are open for flow at the same time.

Alternatively, or additionally, in yet another embodiment, as will be explained in more detail below, the 101 and 101′ comprise outlets, and 201 comprises an inlet, and one fluid flow path can be used for venting and/or biological fluid sampling, and the other fluid flow path can be used for passing the fluid to a device (such as a filter) downstream of the valve. For example, FIG. 22 shows an embodiment of a system including two embodiments of valves, wherein one illustrated valve includes two inlets and an outlet, and can be operated with a vent, preferably comprising a gas inlet, and the other illustrated valve includes one inlet and two outlets, and can be operated with another vent, preferably comprising a gas outlet.

Alternatively, in another embodiment, the valve can be used to provide a first or second fluid flow path, and a combined fluid flow path (i.e., wherein the first and second fluid flow paths are open for flow at the same time). In one embodiment, the valve can be capable of providing two different combined fluid flow paths in different directions through the valve when desired, e.g., allowing fluid flow from the first and second inlets through the outlet, and later, after a conduit downstream of the outlet is sealed or clamped, allowing fluid flow from one inlet into the outlet and then from the outlet through the other inlet.

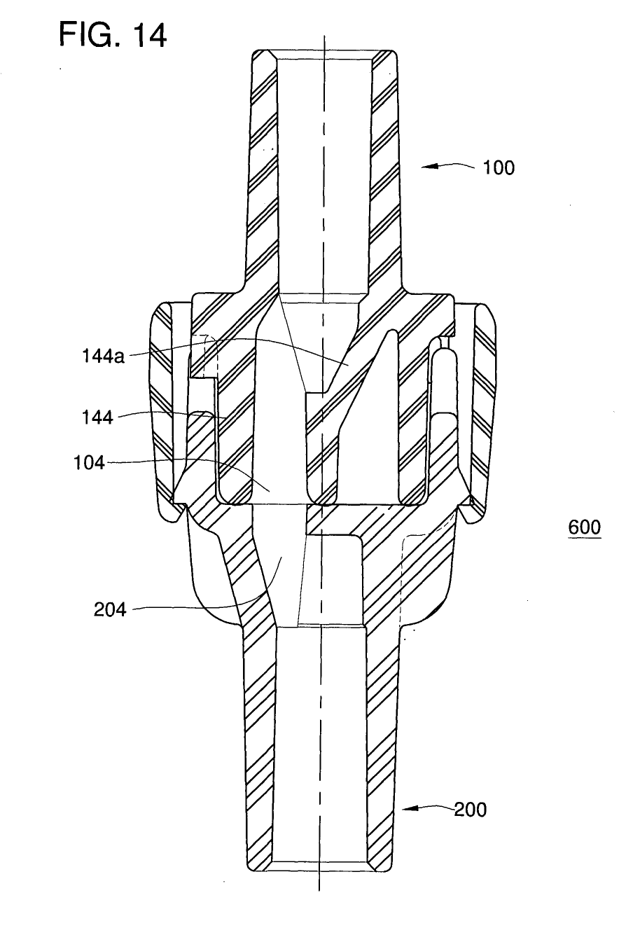

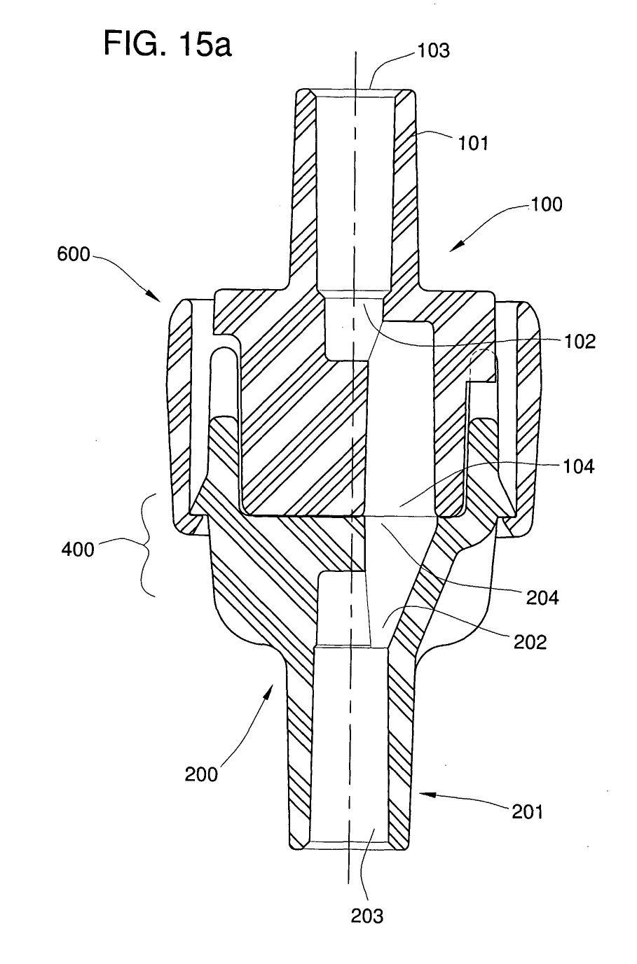

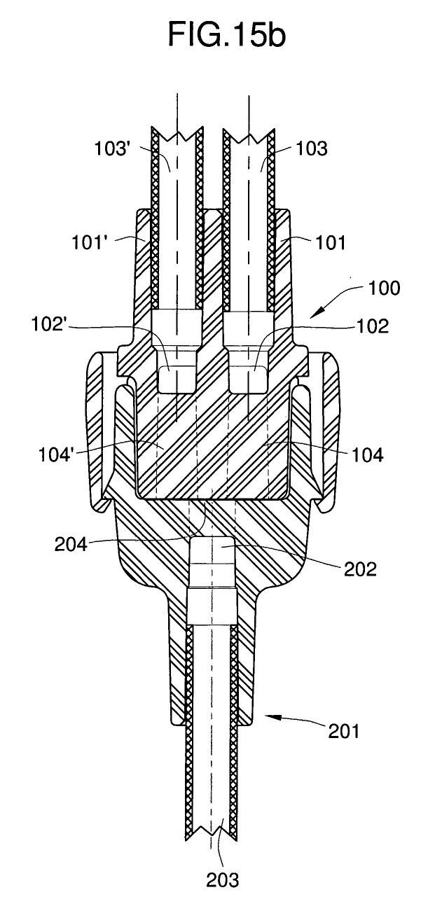

In some embodiments, the valve does not include a gasket. For example, although the embodiments of the valves shown in FIGS. 14 and 15 can have some of the same or similar structures and/or elements as in the embodiments of the valves shown in FIGS. 2, 9, and 13, the embodiments shown in FIGS. 14 and 15 do not include a gasket between the first and second sections. Additionally, the embodiments of valves without a gasket preferably do not include one or more blind holes, ribs and/or grooves in the second section (e.g., in contrast with the second section shown in FIGS. 3 and 4 wherein the valve includes a gasket 500, as well as blind hole 260 and three grooves 251, 252, and 253), as those structures are typically provided for increasing the surface area of the second section contacting the gasket.

In those embodiments wherein the valve lacks a gasket, the proximal end surfaces 143 (and 143a) of the first section 100 are in intimate contact with the proximal end surface 243 of the second section 200 to provide a fluid tight seal while allowing the first section to be rotated with respect to the second section. If desired, the first and second sections can be made from, or comprise portions made from, materials having different compressibility and/or rigidity, e.g., to improve the seal. Illustratively, sections and/or portions of sections can be made from plastic materials (preferably thermoplastic materials), wherein the plastic materials are semi-rigid (e.g., having a hardness value in the range of about 30 to about 70 Shore D), rigid (e.g., having a hardness value in the range of about 80 to about 150 Rockwell R), or elastic (e.g., having a hardness value in the range of about 20 to about 75 Shore A). Typically, Shore A and Shore D values are measured in accordance with ASTM D2240 or ISO 868, and Rockwell R values are measured in accordance with ASTM E18.

For example, a valve can comprise a section having a semi-rigid portion, and another section having a rigid portion, wherein the semi-rigid portion contacts the rigid portion to provide a fluid tight seal without a gasket while allowing the first section to be rotated with respect to the second section. Alternatively, for example, a valve can comprise first and second sections each having a semi-rigid portion, wherein the semi-rigid portion of the first section contacts the semi-rigid portion of the second section to provide a fluid tight seal without a gasket while allowing the first section to be rotated with respect to the second section.

The operation of the embodiments of the valves shown in FIGS. 14 and 15 is essentially the same as that described above with respect to the embodiments shown in FIGS. 2, 9, and 13, i.e., the first section is rotated with respect to the second section so that when the first section is in the second position, open end 104 of the first section is aligned with open end 204 of the second section, and fluid can flow through the valve from the inlet 101 through the outlet 201.

With respect to the operation of the embodiment shown in FIG. 15, and as described with respect to the embodiments shown in FIGS. 9 and 13, when the first section is rotated circumferentially on its axis from the first position, the first section is rotated so that, as desired, the open end 104 moves toward alignment with open end 204 of the second section 200 and/or the open end 104′ moves toward alignment with open end 204 of the second section 201.

Illustratively, when the first section is in the first position, openings 104 and 104′ in the first section 100 face the non-open portion of the surface 243 of the second section 200. When the first section is in one of the second positions (e.g., the “first” second position), open end 204 is aligned with open end 104 of the first section, but not open end 104′. When the first section is in one of the additional second positions (e.g., the “second” second position), open end 204 is aligned with open end 104′ of the first section, but not open end 104. When the first section is in another additional second position (e.g., the “third” second position), open end 204 is aligned with open ends 104 and 104′ of the first section. Thus, when the distal open end 104 of channel 102 in the first section and the distal open end 204 of channel 202 in the second section are aligned, fluid can flow along a first fluid flow path through the valve from the first inlet 101 through the outlet 201. When the distal open end 104′ of channel 102′ in the first section and the distal open end 204 of channel 202 in the second section are aligned, fluid can flow along a second fluid flow path through the valve from the second inlet 101′ through the outlet 201.

When the distal open end 104 of channel 102, the distal open end 104′ of channel 102′, and the distal open end 204 of channel 202, all align, fluid can flow along the first and second fluid flow paths through the valve from the first and second inlets 101 and 101′ through the outlet 201.

The valve can be sterilized as is known in the art. For example, embodiments of the valve can be sterilized by one of more of ethylene oxide, gamma sterilization, e-beam sterilization, and steam sterilization.

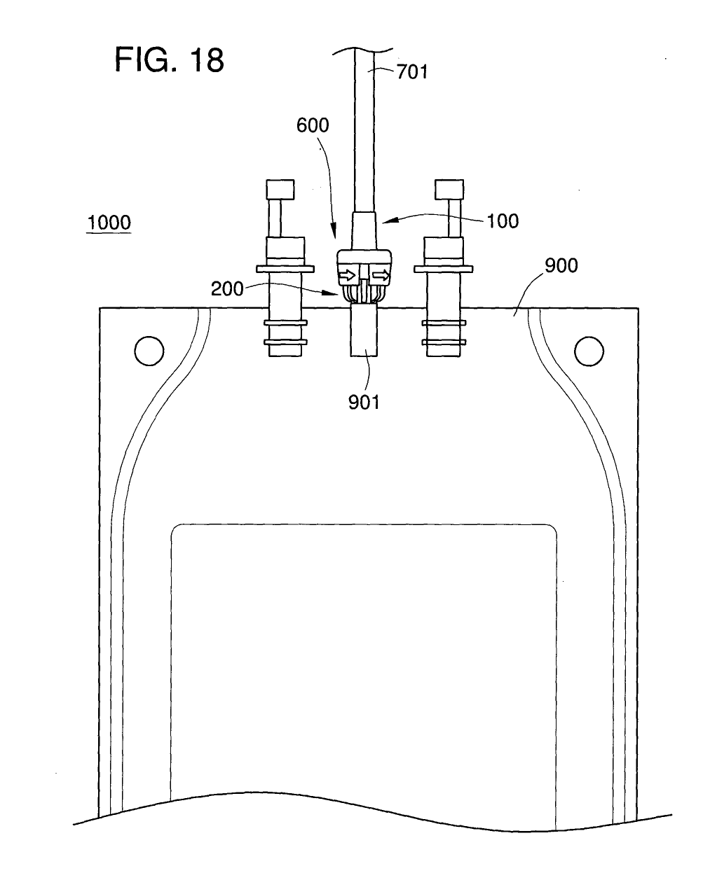

If desired, either or both sections can include indicia, e.g., visual, tactile, and/or auditory indicia to indicate rotation and/or a desired position has been achieved. For example, with respect to visual indicia, either or both sections can include one or more of arrows, symbols, numerals and/or markers, showing the user the direction of rotation and/or positions for desired flow rates. Illustratively, FIGS. 18, 21, and 22 show devices with arrows (showing the user the direction of rotation) and/or numerals (showing the user flow adjustments). Alternatively, or additionally, either, or more preferably, both, sections can further include structures providing tactile and/or auditory feedback to the user to indicate rotation and/or a desired position has been achieved.

In some preferred embodiments, the valve includes a feedback arrangement, that can comprise a locking arrangement, comprising an element associated with each section, wherein the elements interact cooperatively to provide tactile (e.g., the resistance to circumferential rotation changes) and/or auditory (e.g., a clicking or snapping sound is heard) feedback to the user reflecting the rotation and/or position of the first section.

The feedback arrangement can be of any configuration providing tactile and/or auditory information to the user indicating rotation and/or the position of a housing section.

The locking arrangement can be of any configuration that restricts the accidental or inadvertent rotation of a housing section to initiate or prevent fluid flow and/or to modify the fluid flow rate.

For example, the valve can include a locking arrangement comprising an element associated with each section, wherein the first section is initially locked in the first position with respect to the second section, and the elements interact cooperatively to provide the tactile and/or the auditory feedback to the user to indicate when the valve is in the fluid flow position.

Alternatively or additionally, the valve can include a feedback arrangement comprising an element associated with each section, wherein, as the first housing section reaches the second position with respect to the second section, the elements interact cooperatively to provide the tactile and/or auditory feedback to the user. If desired, the feedback arrangement can comprise a locking arrangement configured to resist the reverse rotation of the first section back to the first position after the first section has been rotated to the second position and/or the locking arrangement can be configured to prevent the continued rotation of the first section beyond the second position.

For example, using FIGS. 5-7 for reference, wherein the first section 100 includes a tooth 190 (shown in FIG. 7) and the second section 200 includes a finger 290 (shown in FIGS. 5 and 6), rotating the first section will cause tooth 190 to contact finger 290, and the resistance to rotation will be increased.

Continued rotation will cause the tooth 190 to bend the finger 290, until the finger is bent sufficiently to allow the tooth to slide over or past it. The resistance will then decrease, and a click can be heard. Preferably, the finger is sufficiently resilient to substantially return to its previous upright position, to provide resistance to reverse rotation of the first section back to the first position. Moreover, the second section can be configured to prevent continued rotation of the first section beyond the second position, e.g., the tooth 190 contacting the edge 244c of the upper sidewall 244b prevents further rotation. Accordingly, the valve can be locked in the fluid flow position.

In another variation (not shown), the feedback arrangement comprises a plurality of teeth, e.g., wherein each tooth bends the finger and each click indicates a different flow rate. In some embodiments, the feedback arrangement comprises a ratchet, e.g., wherein a pawl engages a plurality of teeth as the first section is rotated, and reverse rotation is prevented.

With the terms “inlet” and “outlet” are used above, it should be clear that, in accordance with embodiments of the invention, the flow can be in either direction through the valve, e.g., an “inlet” 101 can be an “outlet”, and an “outlet” 201 can be an “inlet.”

For example, using FIG. 9d for reference (using the same reference numbers but reversing the flow), an embodiment of the invention can include one inlet 201 and first and second outlets 101 and 101′. When the distal open end 104 of channel 102 in the first section and the distal open end 204 of channel 202 in the second section align with the opening 504 in the gasket 500, fluid can flow along a first fluid flow path through the valve from the inlet 201 through the first outlet 101. When the distal open end 104′ of channel 101′ in the first section and the distal open end 204 of channel 202 in the second section align with the opening 504 in the gasket 500, fluid can flow along a second fluid flow path through the valve from the inlet 201 through the second outlet 101′.

Thus, when the distal open end 104 of channel 102, the distal open end 104′ of channel 102′, and the distal open end 204 of channel 202, all align with the opening 504 in the gasket 500, fluid can flow along the first and second fluid flow paths through the valve from the inlet 201 through the first and second outlets 101 and 101′.

In illustrative embodiments, inlet 201 is in fluid communication with the outlet of a filter housing (a filter is not required, the inlet 201 can be in fluid communication with, for example, a first biological fluid container such as a collection bag), first outlet 101 is in fluid communication with a biological fluid container such as a satellite bag, and second outlet 101′ is in fluid communication with a gas outlet (e.g., including one or more porous media), or a sampling arrangement.

For example, the first and second fluid flow paths can be initially closed. The second fluid flow path can be opened so that filtered biological fluid passes from the inlet 201 to the second outlet 101′. As the biological fluid passes, it displaces gas in the system and the gas passes through the porous medium (e.g., a porous or microporous hydrophobic membrane) or media (e.g., a porous or microporous hydrophilic membrane and a porous or microporous hydrophobic membrane) of the gas outlet. Once the biological fluid contacts a hydrophobic medium, flow stops, as the biological fluid does not pass through the hydrophobic medium.

The first fluid flow path can then be opened (if desired, the second fluid flow path can remain open) and filtered biological fluid passes from the inlet 201 through the first outlet 101 to a downstream biological fluid container such as a satellite bag.

In another illustrative embodiment, the first and second fluid flow paths can be initially closed. The second fluid flow path can be opened so that filtered biological fluid passes from the inlet 201 through the second outlet 101′ into a sampling arrangement, e.g., comprising a pouch or evacuated container. Once a desired amount of the biological fluid has been obtained, the second fluid flow path can be closed, and the first fluid flow path can be opened, allowing biological fluid to be collected in a downstream biological fluid container.

In yet other embodiments, flow can be in more than one direction through the valve. For example, using FIG. 9d for reference, the inlet 201 can be in fluid communication with the outlet of a filter housing wherein the filter is “backprimeable,” e.g., the filter is primed using priming fluid passed through the outlet of the housing, and through the downstream side of the filter to the upstream side, and toward the inlet of the housing. A first fluid flow path can be opened so that priming fluid (e.g., from a satellite container) can be passed from “outlet” 101 and through “inlet” 201 to backprime the filter. After the filter is primed (and after a fluid flow path upstream of the filter housing is opened), the second fluid flow path can be opened so that biological fluid passes from inlet 201 and through second outlet 101′ to a downstream biological fluid container.

In some embodiments, combined flow can be in more than one direction through the valve. Again, using FIG. 9d for reference, 101 and 101′ can both comprise inlets, and 201 can comprise an outlet at one point in a fluid processing protocol, and when the distal open end 104 of channel 102, the distal open end 104′ of channel 102′, and the distal open end 204 of channel 202, all align with the opening 504 in the gasket 500, fluid can flow along the first and second fluid flow paths through the valve from the first and second inlets 101 and 101′ through the outlet 201. However, at another point in the fluid processing protocol, one of the inlets can become an “outlet.” For example, at the appropriate point in the fluid processing protocol, the fluid flow path downstream of the outlet 201 can be blocked (e.g., a conduit connected to outlet 201 can be clamped or sealed (preferably, heat sealed). While the open ends 104, 104′, and 204 are aligned with the opening 504, fluid can be passed from an “inlet”, e.g., inlet 101, into outlet 201, and, since the conduit connected to outlet 201 is blocked, the fluid subsequently passes from the outlet 201 through 101′, which is now an “outlet.”

There are many alternative ways by which the valve can be configured. For example, in other embodiments (not shown) the first section can include a socket enclosing the gasket, and/or the gasket can be thermally sealed to the first section (rather than the second section) so that the gasket does not move independently of the first section.

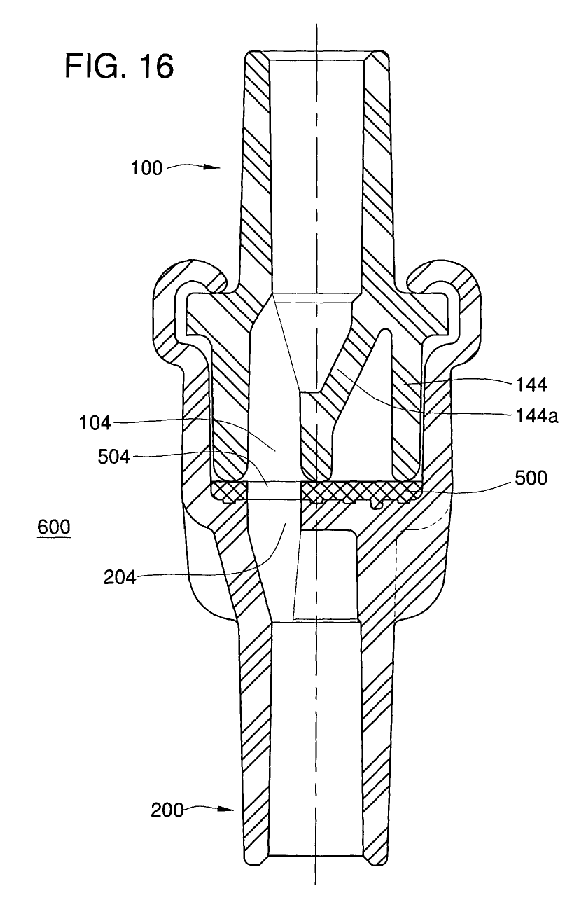

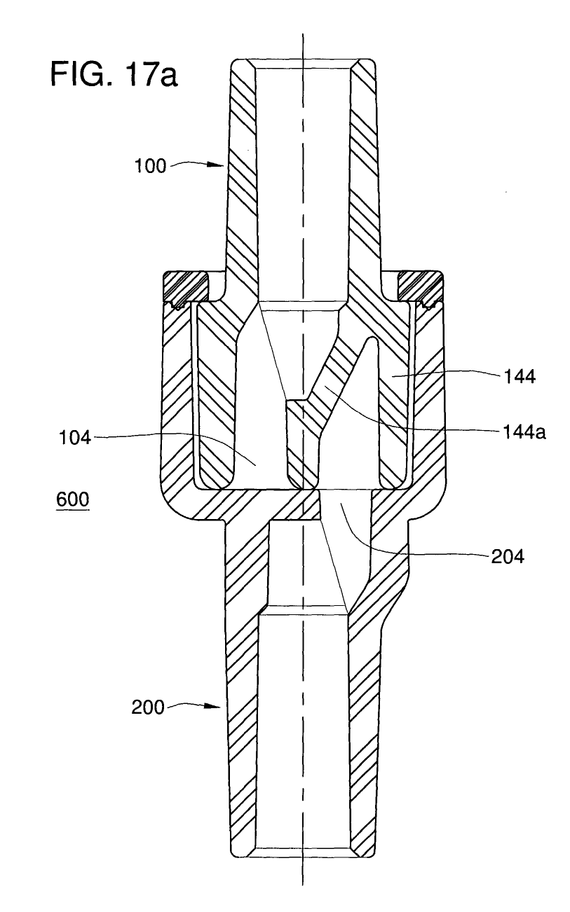

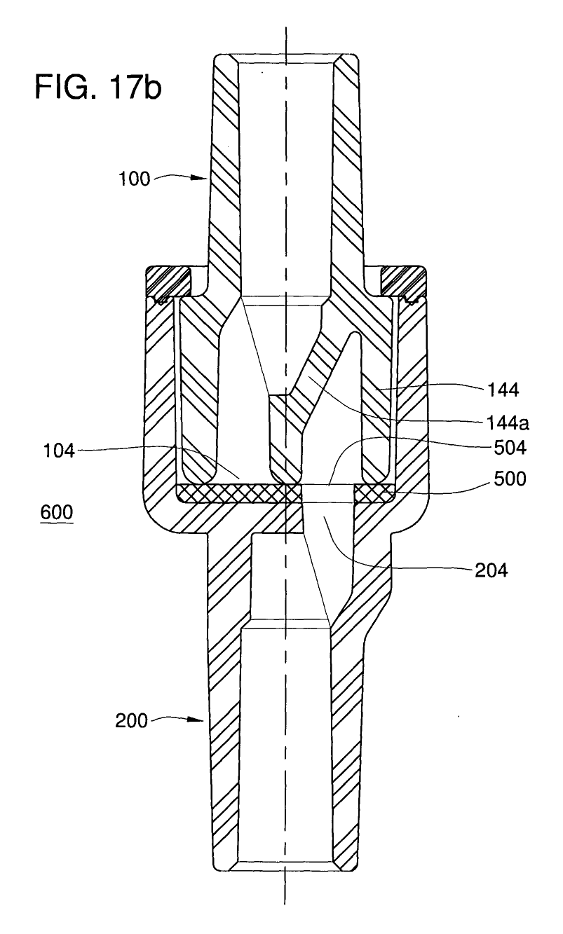

In yet other embodiments, the first and second sections are engaged together utilizing, for example, swaging (e.g., as shown in FIG. 16, wherein one or more portions of the second section have been swaged to provide a retaining collar or a plurality of forks) or ultrasonic sealing (e.g., as shown in FIGS. 17a and 17b). If desired, the first and second sections can be made from different materials and/or at least one section can have different portions made from different materials. For example, the portion to be swaged or ultrasonically sealed can be made of a different (e.g., more rigid) material than the other portions.

The sections of the valve can be attached to, or formed as part of, any suitable conduit or fluid container, such as, for example, a section of tubing, or a flexible container such as a bag. In some embodiments, the valve housing can include additional elements for ease of attachment to conduits and/or containers, for example, one or more nipples (e.g., for push-on connection with tubing) or threads (e.g., for engaging the threads of a connector). Typically, the conduits and containers are flexible conduits and flexible containers as conventionally used in blood collection and/or processing systems, e.g., plasticized PVC tubing and bags.

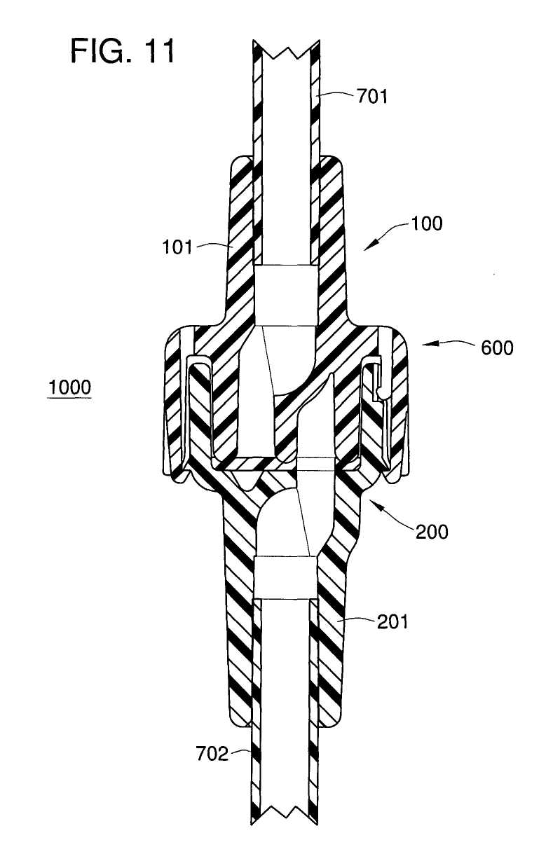

In an embodiment, a fluid processing device comprises an embodiment of the valve as described above, at least one first conduit connected to the first section of the housing, and at least one second conduit connected to the second section of the housing. For example, FIG. 11 illustrates a biological fluid processing device 1000, comprising valve 600 as described with respect to FIG. 1, with a first conduit 701 attached to, and in fluid communication with, the first section 100 (in the illustrated embodiment, the conduit is attached to the inlet 101), and a second conduit 702 attached to, and in fluid communication with, the second section 200 (in the illustrated embodiment, the conduit is attached to the outlet 201).

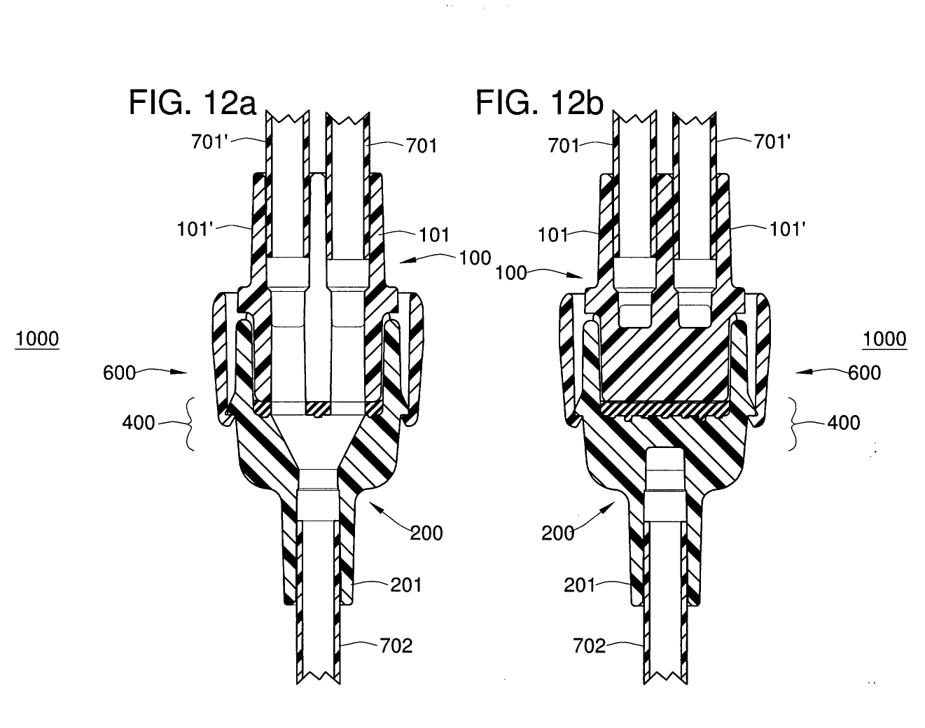

In some embodiments wherein the valve includes one or more additional inlets, the fluid processing device comprises the valve, a plurality of first conduits (e.g., one for each inlet) each first conduit connected to the first section of the housing, and at least one second conduit connected to the second section of the housing. For example, FIG. 12 illustrates a biological fluid processing device 1000, comprising valve 600 as described with respect to FIG. 9, with a first conduit 701 attached to, and in fluid communication with, the first section 100 (in the illustrated embodiment, the conduit is attached to the first inlet 101), an additional first conduit 701′ attached to, and in fluid communication with, the first section 100 (in the illustrated embodiment, the conduit is attached to the additional inlet 101′) and a second conduit 702 attached to, and in fluid communication with, the second section 200 (in the illustrated embodiment, the conduit is attached to the outlet 201).

In another embodiment of the invention, the biological fluid processing device comprises an embodiment of a valve as described above, at least a first conduit connected to the first section of the housing, and a biological fluid container including two or more fluid flow ports, wherein one of the fluid flow ports is connected to the second section of the housing. FIG. 18 illustrates a biological fluid processing device 1000, comprising valve 600 as described with respect to FIG. 1, with a first conduit 701 attached to, and in fluid communication with, the first section 100 (in the illustrated embodiment, the conduit is attached to the inlet 101), and a biological fluid processing container 900, having a plurality of fluid flow ports, wherein fluid flow port 901 is attached to, and in fluid communication with, second section 200.

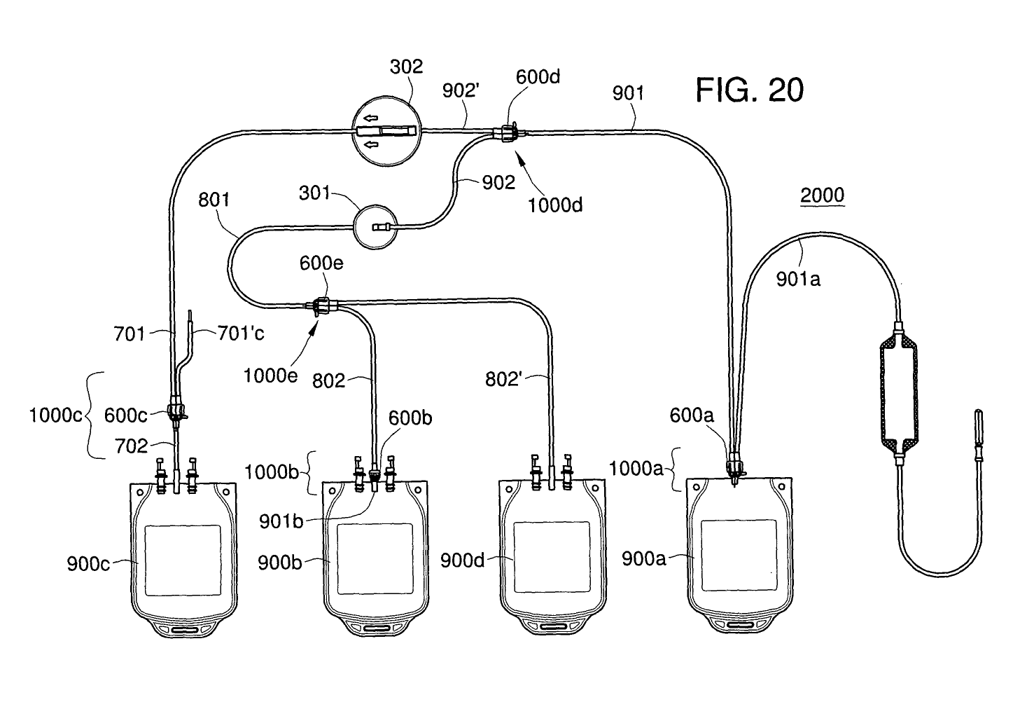

In another embodiment, as shown in FIG. 20, the device comprises the valve as described with respect to FIG. 9, separate conduits attached to the inlets, and a biological fluid processing container comprising a plurality of fluid flow ports, wherein a fluid flow port of the biological fluid processing container is attached to, and in fluid communication with, the second section of the housing.

Embodiments of the invention are especially suitable for use in biological fluid processing systems, e.g., typically including one or more, preferably, two or more, biological fluid containers such as blood collection and/or satellite bags.

For example, an embodiment of a biological fluid processing system comprises a biological fluid processing device including conduits as described above with respect to FIGS. 11 and 12, and a first biological fluid processing container comprising a flexible bag including at least two fluid flow ports, wherein one of the conduits is in fluid communication with a fluid flow port. In a more preferred embodiment, the biological fluid processing container is downstream of the biological fluid processing device, e.g., one end of the second conduit is connected to the second section of the housing, and the other end of the second conduit is attached to a fluid flow port of the biological fluid processing container.

The biological fluid processing system can include at least one additional container, e.g., a flexible bag including at least one fluid flow port, wherein the additional (e.g., second) bag is in fluid communication with the other (e.g., first) conduit. Alternatively, or additionally, embodiments of the biological fluid processing system can include additional containers, e.g., wherein the containers are downstream of, and in fluid communication with, the first or second bags.

In yet another embodiment, a biological fluid processing system is provided, comprising a biological fluid processing device as described above with respect to FIG. 18, and at least one additional biological fluid processing container comprising a flexible bag including at least one fluid flow port, wherein the additional container is upstream or downstream of the biological fluid processing device.

Embodiments of biological fluid processing devices can include two or more conduits. Embodiments of biological fluid processing systems can include two or more conduits, two or more bags and/or two or more valves (e.g., valves themselves and/or biological processing devices that comprise valves). In those embodiments of biological fluid processing systems including two or more valves, a system can include two or more embodiments of valves, e.g., a valve comprising a single inlet and a single outlet, and a valve comprising two or more inlets and/or outlets. Accordingly, flow into a desired conduit and/or container can be controlled by using any embodiment of a valve communicating with the conduit and/or container.

Fluid processing systems in accordance with embodiments of the invention can include additional components, such as, for example, one or more filters, e.g., biological fluid filters such as leukocyte depletion filters, one or more drip chambers, and/or one or more vents, e.g., at least one gas inlet and/or at least one gas outlet.

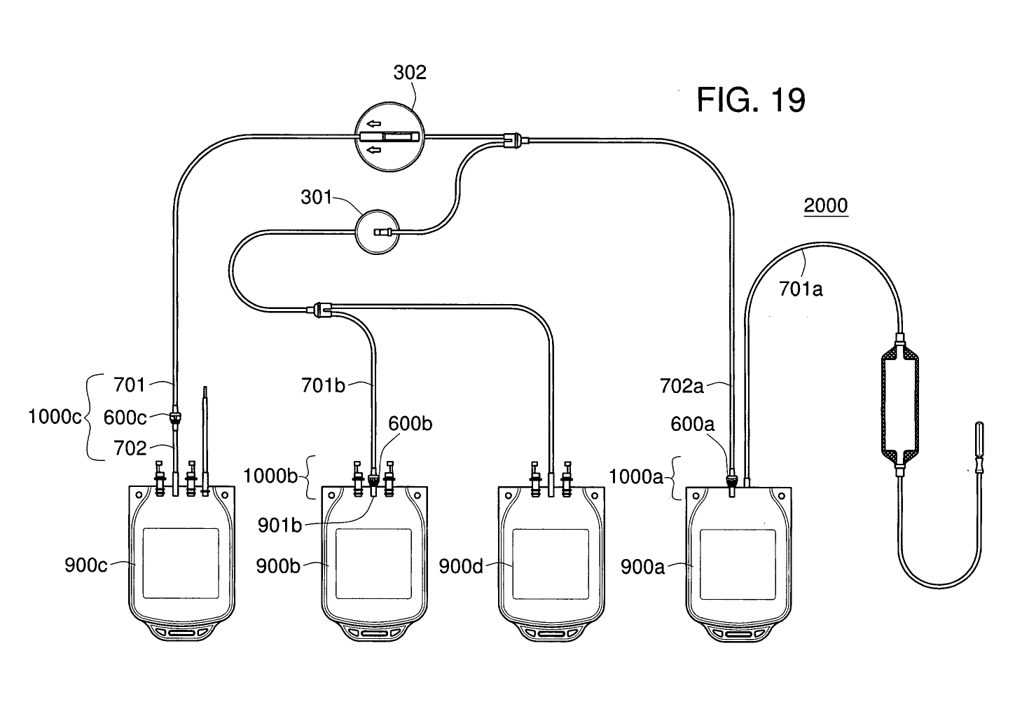

FIG. 19 illustrates an illustrative embodiment of a biological fluid processing system 2000 including a plurality of conduits and containers, and including a plurality of embodiments of biological fluid processing devices 1000 including valves 600 as described above, e.g., wherein a valve having a single inlet and a single outlet is disposed between conduits (device 1000a), or disposed in a port of the flexible bag (devices 1000b and 1000c).

FIG. 20 illustrates another illustrative embodiment of a biological fluid processing system 2000 including a plurality of conduits and containers, and including a plurality of embodiments of biological fluid processing devices 1000 comprising valves 600 as described above, e.g., wherein valves having a single inlet and two outlets (devices 1000d and 1000e), and valves having two inlets and a single outlet (devices 1000a and 1000c), and valves having a single inlet and a single outlet (device 1000b) are disposed between conduits (devices 1000c-e), or disposed in a port of the flexible bag (device 1000a).

With respect to the illustrated embodiments of systems shown in FIGS. 19 and 20, when fluid flow through the valve is desired, a section of the housing is rotated to the appropriate position, and flow proceeds. In accordance with this exemplary system, flow can be from the second section of the housing and through the first section, or from the first section of the housing and through the second section. In some embodiments, flow can be in one direction through the housing during one part of a fluid processing protocol, and in at least one other direction through the housing during another part of a fluid processing protocol. If desired, the valve can be disposed in the system to allow fluid to flow from a container into a conduit, from a conduit into a container, or to allow fluid to flow from one conduit to another.

Additionally, or alternatively, a valve can be disposed in a system to allow fluid to flow into or from any other component of the biological fluid processing system, such as, for example, a biological fluid filter such as a leukocyte filter.

For example, using the embodiment of a system illustrated in FIG. 19, biological fluid processing device 1000a comprising valve 600a can be operated to allow biological fluid to flow from container 900a toward leukocyte depletion filters 301 and 302. With respect to FIG. 20, biological fluid processing device 1000d comprising valve 600d can be operated to allow biological fluid to flow from conduit 901a toward leukocyte depletion filters 301 and 302 (via conduits 902 and 902′, respectively).

As noted above, flow can flow in a variety of directions through the valve during different parts of a fluid processing protocol. For example, in accordance with an embodiment of biological fluid processing using the system shown in FIG. 20, biological fluid processing device 1000d is operated to open a fluid flow path between conduits 901 and 902, to allow platelet-containing fluid to flow through leukocyte depletion filter 301, and biological fluid processing device 1000e can be operated to open a first fluid flow path between conduits 801 and 802′, to allow leukocyte-depleted platelet-containing fluid (e.g., leukocyte-depleted platelet-rich-plasma (PRP)) to be passed into container 900d. The conduit 801 interposed between the filter 301 and the device 1000e is heat-sealed and cut.

Containers 900b and 900d (and the associated tubing and valves) are placed in a centrifuge, and container 900d is centrifuged to allow the platelets to be concentrated at the bottom of the container. The containers are removed from the centrifuge, device 1000b is opened, and the device 1000e is operated to open both fluid flow paths, i.e., between conduits 802′ and 801 (conduit 801 has been sealed), and conduits 801 and 802. Subsequently, plasma is expressed from container 900d to container 900b. Since the conduit connected to 801 has been heat sealed, plasma passes from container 900d, conduit 802′, and into the housing, and then from the housing through conduit 802 into container 900b.

FIG. 21 illustrates another embodiment of a fluid processing system wherein a fluid processing device can be operated to adjust flow rates through the device and the user can adjust the flow rates as desired. For example, with respect to the system illustrated in FIG. 21, wherein the upstream source container 900 contains fluid to be administered, the user can adjust the device 1000 (e.g., with reference to indicia on the housing and to a flow indicator device such as a drip chamber 950) to uncover more of the open area of the gasket. The user can continue to adjust the flow, if desired.

FIG. 22 illustrates an embodiment of a system 2000 including a first vent 450a and a second vent 450b, wherein the first vent 450a is attached to first biological fluid processing device 1000a (comprising valve 600a and conduits 701, 701′, and 702), the second vent 450b is attached to second biological fluid processing device 1000b (comprising valve 600b and conduits 801, 802, and 802′), and a filter 302 is interposed between the first and second processing devices. Vents 450a and 450b each comprise a housing having at least first and second ports and at least one porous medium (preferably, comprising at least one microporous hydrophobic membrane, more preferably, the membrane having a bacterial blocking pore rating). Preferably, the vents allow gas to pass through the porous media while maintaining a closed system. Suitable vents (e.g., gas inlets and/or gas outlets) include, but are not limited to, those disclosed in U.S. Pat. Nos. 5,126,054, 5,451,321, 5,472,605, and 5,902,490.

In accordance with a typical operation of the system illustrated in FIG. 22, wherein container 900a contains a leukocyte-containing biological fluid, device 1000b is operated to open the fluid flow path between conduit 801 and 802′, while keeping the fluid flow path between 801 and 802 closed, and device 1000a is operated to open the fluid flow path between conduit 701 and 702, while keeping the fluid flow path between 701′ and 802 closed. Biological fluid passes from container 900a through leukocyte depletion filter 302. Gas (air) displaced by the biological fluid passes through the vent 450b.

After the gas is displaced from the system, device 1000b is operated to open the fluid flow path between 801 and 802, and close the fluid flow path between 801 and 802′. Leukocyte depleted biological fluid passes into container 900b. After the flow of leukocyte depleted biological fluid into container 900b stops, device 1000a is operated to open the fluid flow path between 701′ and 702, and close the fluid flow path between 701 and 702. Gas passes through vent 450a into conduit 701′, and additional leukocyte depleted biological fluid passes into container 900b.

In accordance with other embodiments, either or both of the vents are operated to allow other fluid flow paths to be open and/or closed at other points in the fluid processing protocol. For example, in one embodiment, first vent 450a is operated to allow the first, second, and combined fluid flow paths open at the same time during a part of the fluid processing protocol.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A valve comprising:
a housing comprising a first section comprising a thermoplastic material and a second section comprising a thermoplastic material;
the first section comprising at least one inlet;
the second section comprising at least one outlet;
wherein the first section is rotatably engaged with the second section, and, while the sections are engaged, one section can be rotated with respect to the other section from a first position wherein fluid flow through the housing is prevented to a second position allowing fluid flow through the housing.

2. The valve of claim 1, wherein the first section further comprises at least one inlet fluid flow channel;
the second section further comprises at least one outlet fluid flow channel;
wherein, while the sections are engaged, the first section is rotatable with respect to the second section from a first position that prevents fluid flow through the housing, to a second position that allows fluid flow through the housing.

3. (canceled)

4. The valve of claim 1, wherein the valve comprises a gasket interposed between the first section and the second section, the gasket including at least one opening for allowing fluid flow therethrough, and, while the sections are engaged with the gasket interposed between the sections, one section can be rotated with respect to the other section from a first position wherein fluid flow through the housing is prevented to a second position allowing fluid flow through the housing.

5. (canceled)

6. (canceled)

7. The valve of claim 1, wherein the section can be rotated within the second position to provide a different desired fluid flow rate through the housing.

8. The valve of claim 1, wherein the gasket includes more than one opening that allows fluid flow therethrough when one section is rotated with respect to the other section to the second position.

9. The valve of claim 1, wherein the first section includes at least one first channel, and the second section includes at least one second channel, and,
when the sections are in the first position that prevents fluid flow through the housing, the first and second channels are not aligned to allow fluid flow from the first channel to the second channel, and
when one section is rotated with respect to the other section to the second position that allows fluid flow through the housing, the first and second channels are aligned to allow fluid flow from the first channel to the second channel.

10. The valve of claim 1, including a locking mechanism that prevents movement of the rotated section from the second position back to the first position.

11. The valve of claim 1, including a visual indicator showing the rotatable section is in the first or second positions.

12. The valve of claim 1, including an audible indicator indicating the rotatable section is in the first or second positions.

13. The valve of claim 1, wherein the first section is frictionally engaged with the second section.

14. The valve of claim 1, further comprising at least one conduit connected to the first section.

15. The valve of claim 1, further comprising at least one conduit connected to the second section.

16. The valve of claim 1, further comprising a fluid processing container having at least first and second fluid flow ports, wherein the first fluid flow port is connected to the second section.

17. A biological fluid processing system comprising
a flexible container suitable for containing a biological fluid, the container including at least first and second fluid flow ports; and
the valve of claim 1, in fluid communication with the first fluid flow port.

18. A method for processing a biological fluid comprising:
rotating a first section of a valve rotatably engaged with a second section of the valve from a first position with respect to the second section to a second position, wherein the first position prevents fluid flow through the housing and the second position allows fluid flow through the housing; and
passing biological fluid from a blood bag and through the valve.

19. The method of claim 18, wherein the valve comprises a gasket including at least one opening capable of allowing fluid flow therethrough, and the gasket is interposed between the first section and the second section.

20. (canceled)

21. The method of claim 18, comprising passing the biological fluid from the valve and into a blood bag.

22. The method of claim 18, carried out in a closed system.

23. The valve claim 4, including a locking mechanism that prevents movement of the rotated section from the second position back to the first position.

24. The system of claim 17, wherein the valve comprises a gasket interposed between the first section and the second section, the gasket including at least one opening for allowing fluid flow therethrough, and, while the sections are engaged with the gasket interposed between the sections, one section can be rotated with respect to the other section from a first position wherein fluid flow through the housing is prevented to a second position allowing fluid flow through the housing.

25. The system of claim 24, wherein the valve includes a locking mechanism that prevents movement of the rotated section from the second position back to the first position.

26. The system of claim 25, comprising a closed system.
